(19) United States
(12) Patent Application Publication
(10) Pub. No.: US 2021/0155882 A1
(43) Pub. Date: May 27, 2021

(54) FORMULATIONS, METHOD AND SYSTEM FOR REDUCING ENERGY AND WATER USAGE IN AN INSTITUTIONAL LAUNDRY

(71) Applicant: Diversey, Inc., Fort Mill, SC (US)

(72) Inventors: Amit Ranarao JAGTAP, Thane (IN); Devchand Nivrutee AVHAD, Mumbai (IN); Nikhil D. SHIRSAT, Thane (IN); Yashesh Prafull LODAYA, Mumbai (IN); Parag A. WASEKAR, Wardha (IN); Pratiksha S. PEDNEKAR, Mumbai (IN); Anant PARTE, Charlotte, NC (US)

(21) Appl. No.: 17/054,257

(22) PCT Filed: May 13, 2019
(86) PCT No.: PCT/US19/31955

§ 371 Date: Nov. 10, 2020

(30) Foreign Application Priority Data
May 11, 2018 (IN) 201811017826

(51) Int. Cl. C11D 11/00; C11D 1/83; C11D 3/386; C11D 3/395; C11D 3/43

(52) U.S. Cl. CPC C11D 11/0064; C11D 11/0017; C11D 1/83; C11D 3/38627; C11D 3/3869; C11D 1/72; C11D 3/3956; C11D 3/3955; C11D 3/3953; C11D 3/3951; C11D 3/43; C11D 3/38636

(57) ABSTRACT

Formulations, methods using such a formulation, and systems encompassing such formulations and methods for reducing energy and/or water usage in an institutional laundry is provided. Such formulations, methods and systems allow for textiles and fabrics to be effectively washed even at temperatures as low as 20° C. A prewash formulation includes a surfactant enzyme booster with the surfactant enzyme booster having one but preferably more enzymes and one or more surfactants. The enzyme of the prewash formulation may include any one or more of a protease, a lipase, an amylase, a cellulase, a mannanase, a pectinase, a peroxidase, and a gluconase. A main wash formulation is used in a wash phase cycle of an institutional laundry where such a main wash formulation includes a bleach, bleach enhancer, a chelating agent, an anti-redeposition agent and/or a soil suspension agent, a surfactant, preferably a nonionic surfactant and an anionic surfactant, a solvent including an aqueous solvent and perhaps an organic solvent, and a builder. An institutional washing process using the formulations provided here are distinguished by the need to only include one rinse cycle—i.e., a rinse cycle between the prewash cycle and the main wash cycle is generally not needed or, at least, a full rinse cycle between the prewash cycle and the main wash cycle is not needed. The formulations, methods and systems provided reduce energy and water usage in an institutional laundry.

### CROSS-REFERENCE TO RELATED APPLICATIONS

This application claims priority to Indian Provisional Application No. 201811017826, filed on May 11, 2018, which is incorporated herein by reference in its entirety.

### FIELD OF INVENTION

The present invention relates to formulations, methods using such formulation, and systems encompassing such formulation and methods for reducing energy and/or water usage in an institutional laundry.

### BACKGROUND

Institutional laundries include those facilities typically found in schools, hotels, military establishments, and the like. Industrial and institutional laundering of fabrics and textiles has conventionally relied upon the use of large amounts of strong alkalis (e.g. sodium hydroxide and potassium hydroxide), builders and surfactants at high wash temperatures to obtain good cleaning results. Furthermore, extensive use of strong alkalis and chlorine bleach has a negative effect on the lifetime of the textile. From an environmental perspective, reducing the amount of alkalis, chlorine, builders and surfactants is also beneficial since a lesser amount of chemicals in use results in less waste water and/or a lower chemical oxygen demand in the waste water.

Conventional benchmark wash programs for institutional laundries operate at a variety of temperatures but typically within the range of about 50° C. to about 80° C. The wash programs are bleach specific where main wash bleaching temperature is dependent on the bleach system being used. Typical bleaching systems currently in use by benchmark wash programs include phthalimidoperhexenoic acid (operates at about 50° C.), peracetic acid (operates at 60° C.) and hydrogen peroxide (operates at 80° C.).

The most energy/water efficient benchmark wash program operating at 50° C. consumes approximately 1.32 kWh electricity per kilogram of fabric and uses approximately 17.2 liters of water per kilogram of fabric being washed. The electricity and water consumption for other benchmark wash programs operating at 60° C. and 80° C. for instance require greater than 1.32 kWh electricity per kilogram of fabric and consumes more than approximately 17.2 liters water per kilogram of fabric being washed.

In addition to the motivation for a drive towards efficiency in existing institutional laundry facilities, expansion of these types of facilities into third world countries creates a need for reduction in energy usage and water usage within these facilities. Since conventional industrial and institutional wash processes are normally carried out at a high temperature, any reduction in the wash temperature will benefit both the industrial washing company and/or the institution by reducing energy bills and the impact the release of high temperature waster waters has on the environmental. There remains a need in the art for formulations, methods of washing, and systems encompassing such formulations and methods to reduce the energy use required in an industrial or institutional laundry and to reduce the amount of water needed in such processes.

### SUMMARY OF INVENTION

The present invention provides formulations for use in an institutional laundry allowing for one or both of reduced energy consumption and reduced water consumption in the cleaning process. Methods using such formulations of the invention in an institutional laundry are also provided. Systems having the formulation and the methods of the invention providing for reduced energy consumption and/or reduced water usage in an institutional laundry are also provided. Without intending to be bound by the theory, cleaning systems providing a reduced number of rinse cycles in the cleaning process of an institutional laundry, generally provide for a reduction in the amount of water needed in the overall process.

An aspect of the invention provides a detergent formulation for a main wash process of an institutional laundry machine comprising a bleach agent; a bleach enhancer; a chelate agent; an anti-redeposition agent; and a builder. In an embodiment of the invention, a temperature in a wash solution of the institutional laundry machine using the detergent formulation does not exceed about 20° C.

In certain embodiments of the invention, the bleach agent comprises hydrogen peroxide, peracetic acid, chlorine, a peroxy phthalimido alkanoic acid, and any combination thereof. In certain embodiments of the invention, a pH of the wash solution is from about 11 to about 12 when the bleach agent includes hydrogen peroxide, from about 9 to about 9.5 when the bleach agent includes peracetic acid, from about 9 to about 10 when the bleach agent includes chlorine, and from about 8.5 to about 9 when the bleach agent includes peroxy phthalimido alkanoic acid.

The detergent formulation may additionally comprise an enzyme, according to an embodiment of the invention. Further pursuant to this embodiment of the invention, the enzyme comprises a laccase enzyme.

In certain embodiments of the invention, the bleach enhancer of the detergent formulation comprises citric acid and any salt thereof, potassium sodium persulfate, manganese gluconate, a laccase enzyme, and any combination thereof. Further pursuant to this embodiment of the invention, the wash solution comprises any one of from about 150 ppm to about 250 ppm of citric acid and any salt thereof, from about 150 ppm to about 250 ppm of potassium sodium persulfate, from about 2 ppm to about 7 ppm of manganese gluconate, from about 50 ppm to about 70 ppm of laccase enzyme, and any combination thereof.

In certain embodiments of the invention, the chelate agent comprises a methylglycinediacetic acid and any salt and derivative thereof. In other embodiments of the invention, the anti-redeposition agent comprises carboxymethyl cellulose.

The builder of the detergent formulation, according to an embodiment of the invention, may comprise vinylpyrrolidone and vinylimidazole copolymer, an acrylic acid homopolymer, a double salt of potassium sulfate and aluminum sulfate, a mixture of an aromatic polyester and a zeolite, a vinylpyrrolidone polymer, and any combination thereof.

In an embodiment of the invention, a prewash formulation is used in conjunction with the detergent formulation, the prewash formulation comprising an enzyme; and a surfactant. In certain embodiments of the invention, LEVITT® integrate 100 L provides the enzyme and the surfactant of the prewash formulation. In certain embodiments of the invention, the enzyme of the prewash formulation comprises a protease enzyme, a lipase enzyme, an amylase enzyme, a cellulase enzyme, a mannanase enzyme, and a pectinase enzyme. In still other embodiments of the invention, the surfactant of the prewash formulation comprises a non-ionic surfactant and an anionic surfactant. Further pursuant to this embodiment of the invention, the non-ionic surfactant comprises an alcohol ethoxylate. Still further pursuant to this embodiment of the invention, the alcohol ethoxylate has an average of from about C10 to about C18 alcohol ethoxylate and an average of from about 3 moles to about 7 moles of ethylene oxide. In certain embodiments, the alcohol ethoxylate comprises at least one of a linear alcohol ethoxylate and a branched alcohol ethoxylate. Still further pursuant to this embodiment of the invention, the alcohol ethoxylate has an average of from about C11 to about C14, C13-rich iso alcohol ethoxylate and an average of about 8 moles of ethylene oxide.

In some embodiments of the invention, the anionic surfactant of the prewash formulation comprises an oleic acid and any salt thereof, an alkylbenzene sulfonic acid and any salt thereof, and any combination thereof. In certain embodiments of the invention, the prewash formulation additionally comprises an organic solvent. Further pursuant to this embodiment of the invention, the organic solvent comprises a glycolic solvent that may comprise propylene glycol, a glycerol, and any combination thereof.

In an embodiment of the invention, the surfactant enzyme booster formulation additionally comprises a polyphosphate salt; while in other embodiments of the invention, the surfactant enzyme booster formulation is substantially free of a phosphate.

Another aspect of the invention provides a method of cleaning a fabric in an institutional laundry machine comprising the steps of prewashing the fabric by including a surfactant enzyme booster formulation in a wash solution; washing the fabric by including a detergent formulation in the wash solution; at least one of draining and extracting the wash solution to remove any remaining and spent surfactant enzyme booster formulation and detergent formulation from the fabric; and rinsing the fabric using an aqueous solution. In an embodiment of the invention, a temperature in the institutional laundry machine during the cleaning does not exceed about 20° C. In certain embodiments of the invention, a pH of the prewashing step is about 7. In an embodiment of the invention, the institutional laundry machine is not subjected to draining following the prewashing step and before the washing step.

In certain embodiments of the invention, the surfactant enzyme booster formulation comprises a surfactant and an enzyme; while in some embodiments of the invention, LEVITT® integrate 100 L provides the surfactant and the enzyme of the prewash formulation. In certain embodiments of the invention, the enzyme comprises a protease enzyme, a lipase enzyme, an amylase enzyme, a cellulase enzyme, a mannanase enzyme, and a pectinase enzyme. In some embodiments of the invention, the surfactant comprises a non-ionic surfactant and an anionic surfactant, for example, an alcohol ethoxylate. Further pursuant to this embodiment of the invention, the alcohol ethoxylate may have an average of from about C10 to about C18 linear alcohol ethoxylate and an average of from about 3 moles to about 7 moles of ethylene oxide. In some embodiments of the invention, the alcohol ethoxylate comprises at least one of a linear alcohol ethoxylate and a branched alcohol ethoxylate. The alcohol ethoxylate may alternatively have an average of from about C11 to about C14, C13-rich iso alcohol ethoxylate and an average of about 8 moles of ethylene oxide.

In certain embodiments of the invention, the anionic surfactant comprises an oleic acid and any salt thereof, an alkylbenzene sulfonic acid and any salt thereof, and any combination thereof.

In some embodiments of the invention, the surfactant enzyme booster formulation additionally comprises an organic solvent such as, for example, a glycolic solvent comprising propylene glycol, a glycerol, and any combination thereof.

In some embodiments of the invention, the surfactant enzyme booster formulation additionally comprises a polyphosphate salt; while in other embodiments of the invention, the surfactant enzyme booster formulation is substantially free of a phosphate.

Further pursuant to this method, the washing the fabric step comprises raising a pH of the wash solution anywhere in a range of from about 7 to about 9 using a portion of the detergent formulation, and adding a remainder of the detergent formulation and a bleach agent to the wash solution.

In certain embodiments of the invention, the bleach agent substantially inactivates any active enzymes remaining in the wash solution. Thus, in certain embodiments of the invention, the detergent formulation comprises a bleach agent and a bleach enhancer. Further pursuant to this embodiment of the invention, the bleach agent comprises hydrogen peroxide, peracetic acid, chlorine, a peroxy phthalimido alkanoic acid, and any combination thereof. In an embodiment of the invention, the pH of the wash solution, depending on which bleach agent is used, is from about 11 to about 12 when the bleach agent includes hydrogen peroxide, from about 9 to about 9.5 when the bleach agent includes peracetic acid, from about 9 to about 10 when the bleach agent includes chlorine, and from about 8.5 to about 9 when the bleach agent includes peroxy phthalimido alkanoic acid.

In certain embodiments of the invention, the detergent formulation additionally comprises an enzyme such as, for example, a laccase enzyme. In certain embodiments of the invention, an oxidoreductases enzyme, a lacases enzyme may be used in the detergent formulation. In certain embodiments of the invention, the bleach enhancer comprises citric acid and any salt thereof, potassium sodium persulfate, manganese gluconate, a laccase enzyme, and any combination thereof.

In certain embodiments of the invention, the detergent formulation additionally comprises a chelate agent. Further pursuant to this embodiment of the invention, the chelate agent comprises a methylglycinediacetic acid and any salt and derivative thereof.

In certain embodiments of the invention, the detergent formulation additionally comprises an anti-redeposition agent such as, for example, carboxymethyl cellulose.

In certain embodiments of the invention, the detergent formulation additionally comprises a builder. Further pursuant to this embodiment of the invention, the builder comprises vinylpyrrolidone and vinylimidazole copolymer, an acrylic acid homopolymer, a double salt of potassium sulfate and aluminum sulfate, a mixture of an aromatic polyester and a zeolite, a vinylpyrrolidone polymer, and any combination thereof.

In an embodiment of the invention, the extracting may comprise a low speed extracting.

In yet another aspect of the invention, the invention provides a system for cleaning a fabric in an institutional laundry machine including a prewash stage where a surfactant enzyme booster formulation is introduced to a wash solution of the fabric; a main wash stage where a detergent formulation is introduced to the wash solution; at least one of a drain and an extraction stage for the wash solution where any remaining and spent surfactant enzyme booster formulation and detergent formulation are removed from the fabric; and a rinse stage where an aqueous solution rinses the fabric. In an embodiment of the invention, a temperature in the institutional laundry machine during each stage does not exceed about 20° C. In certain embodiments of the invention, the surfactant enzyme booster formulation comprises an enzyme; and a surfactant. In certain embodiments of the invention, a pH of the prewash stage is about 7.

In certain embodiment of the invention, the detergent formulation for the system includes a bleach agent; a bleach enhancer; a chelate agent; an anti-redeposition agent; and a builder.

Furthermore, the system of of the invention may have a main wash stage that comprises a first stage where a portion of the detergent formulation is used to raise a pH of the wash solution anywhere in a range of from about 7 to about 9, and a second stage where a remainder of the detergent formulation and a bleach agent is added to the wash solution.

In certain embodiments of the invention, the bleach agent substantially inactivates any active enzymes remaining in the wash solution.

Other aspects and embodiments will become apparent upon review of the following description. The invention, though, is pointed out with particularity by the included claims.

### BRIEF DESCRIPTION OF THE DRAWINGS

Having thus described the invention in general terms, reference will now be made to the accompanying drawings, which are not necessarily drawn to scale, and wherein:

FIG. 1 is a bar chart showing the relative performance of various enzymes in an institutional laundry, the expected additive relative performance of such enzymes, and the actual relative performance of a combination of the enzymes according to an embodiment of the invention;

FIG. 2 is a bar chart showing the individual performance for surfactants and enzymes in an institutional laundry and the performance when the surfactants and enzymes are used in combination for varying types of soils according to another embodiment of the invention;

FIG. 3 is a graphical comparison of the resources used in a conventional institutional laundry versus the resources used in an institutional laundry of the invention;

FIG. 4 is a process flow diagram of a conventional method for washing a fabric in an institutional laundry; and

FIG. 5 is a process flow diagram of a method for washing a fabric in an institutional laundry according to an embodiment of the invention.

### DETAILED DESCRIPTION OF THE INVENTION

The present invention now will be described more fully hereinafter. Preferred embodiments of the invention may be described, but this invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments of the invention are not to be interpreted in any way as limiting the invention.

As used in the specification and in the appended claims, the singular forms “a”, “an”, and “the” include plural referents unless the context clearly indicates otherwise. For example, reference to “an enzyme” includes a plurality of such enzymes.

Although specific terms are employed herein, they are used in a generic and descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

As may be used interchangeably herein, a “chelant”, “chelating agent” or “sequestrant” is a substance that binds with ions including bi-valent ions for example, but not limited to, calcium and magnesium ions. A chelating agent includes a compound capable of isolating or inactivating a metal ion that may be present in the wash solution by developing a complex that prevents the metal ion from readily participating in or catalyzing chemical reactions. A chelant, chelating agent or sequestrant complex may prevent certain metal ions from precipitating on the surface of fabrics being treated. For example, water present in the equipment for cleaning purposes may include calcium cations (Ca²⁺) and magnesium cations (Mg²⁺) that determine the hardness of the water. A chelating agent may be included that complex with Ca²⁺ and Mg²⁺ metal ions to prevent the precipitation of such compounds with phosphates, sulfates or carbonates. In addition to a chelating agent providing improved control of water hardness, a chelating agent may assist with the control of dissolved free fatty acids from saponified fats by preventing the build-up of Ca- or Mg-soaps. In a non-limiting example, sodium stearate is soluble in water that will cause the stearate to remain in the solution. However, upon saponification, calcium stearate may instead be formed, which is largely insoluble in water and cannot be rinsed from the solution causing. Thus a chelating agent avoids such formation of calcium stearate.

As used herein, the term “enzyme” may catalyze the breakdown of proteinaceous materials and/or organic soil that have become deposited on a fabric for instance. It is not preferred to use any such enzymes at higher temperatures—typically above 60° C.—since enzymes are susceptible to breakdown at these higher temperatures. It is more preferable to use enzymes for cleaning, even more preferably, in the range of from about 20° C. to about 50° C. Proteases (break down protein), amylases (break down starch) and lipases (break down fats) are the most commonly used types of enzymes in cleaning systems, although the enzymes of the formulations disclosed herein are not limited only to these types of enzymes.

A protease (also called a peptidase or proteinase) is any enzyme that performs proteolysis; protein catabolism by hydrolysis of peptide bonds. Proteases have evolved multiple times, and different classes of protease can perform the same reaction by completely different catalytic mechanisms. Proteases can be found in animalia, plantae, fungi, bacteria, archaea and viruses. Generally, proteases are classified in several broad groups by the catalytic types including, but not limited to, serine, cysteine, aspartic, and metallo proteases (zinc).

The native 3D structure of enzymes is stabilized by various effects, e.g. by mono- and divalent ions, disulfide bonds, hydrogen bonds and hydrophobic interaction. Depending on the specific 3D structure and stabilization, thereof, there are several inactivation steps applicable. Hydrogen bonds and hydrophobic interactions can be influenced by an increase of pH and temperature for all proteases, but the acceptable band of pH and temperature can be limited by the fabrics to be treated in the institutional laundry.

Calcium, in a non-limiting example, is essential for the stability of an enzyme. Some enzyme types have the Ca-ion very strongly bound in their structure, whereas other enzymes may more easily release the Ca-ion into the surrounded water. In case there is no water hardness present, there can be an equilibrium between the Ca-ion in the enzyme structure and its release to the water phase. The “free available” Ca-ion in the water phase can be bound to a chelating agent or a chelant, a phosphonate or any combination of these substances. The enzyme can be deactivated by releasing its Ca-ion in an environment where there is no Ca-ion present. The released Ca-ion is then bound stronger to for example a chelant. As a result there is no available free Ca-ion to stabilize the enzyme and the enzyme does not remain active.

As used herein, the term “institutional laundry” is intended to mean a wash machine or a washing operation employed in an institutional setting. In addition to use of the term “institutional laundry” as used herein, “industrial laundry” or “commercial laundry” that may be used herein are also intended to mean an “institutional laundry.”

As used herein, the term “substantially free” should be interpreted to mean less than about 0.1 wt % of the referenced compound.

As used herein, the term “surfactant” means an active cleaning agent of a cleaning solution that may perform any combination of wetting and even penetrating the soil in the fabric to be cleaned, loosening deposited soils at the surface of the fabric, and emulsifying the soils to keep them suspended in solution for removal from the institutional laundry equipment. Surfactants tend to also reduce the surface tension in the cleaning solution. Surfactants may be selected that are polar or hydrophilic in nature, such as negatively charged or anionic surfactant. Surfactants may be selected that are non-polar or hydrophobic in nature, such as nonionic surfactants having no charge. Amphoteric surfactants that behave like anionic, cationic and nonionic surfactants, depending on pH, can also be used. Conventionally, surfactants have been chosen in cleaning solutions for a particular temperature of use.

As may be used herein, “vol %” refers to the percentage of a named compound based upon the volume of the compound relative to total volume of the solution the compound is embodied within unless expressly provided otherwise.

As used herein, “wt %” refers to the percentage of a named compound based upon the weight of the compound relative to total weight of the solution the compound is embodied within unless expressly provided otherwise.

The inventors have conceived of a way to reduce the energy and/or water consumption in an institutional laundry. The invention encompasses one or more formulations to achieve such energy and/or water consumption in an institutional laundry. The invention also encompasses a method of achieving energy and/or water consumption in an institutional laundry. The inventors have also conceived of a system for employee the formulations and methods of the invention to achieve the energy and/or water usage in an institutional laundry.

An aspect of the invention provides a formulation for use in an institutional laundry that assists with the reduction in temperature in the institutional laundry treatment process. In an embodiment of the invention, such a formulation assists with the reduction of water need in the institutional laundry. In yet another embodiment of the invention, the formulation allows both the reduction of energy and water usage in an institutional laundry. In certain embodiments of the invention, a combination of formulations are used to achieve any such reductions in energy and/or water usage.

In an embodiment of the invention, a formulation is provided that may be used in a prewash phase of an institutional laundry.

Table 1 shows the relative individual performance of certain enzymes and the relative performance of the enzymes when used in combination in a wash formulation.

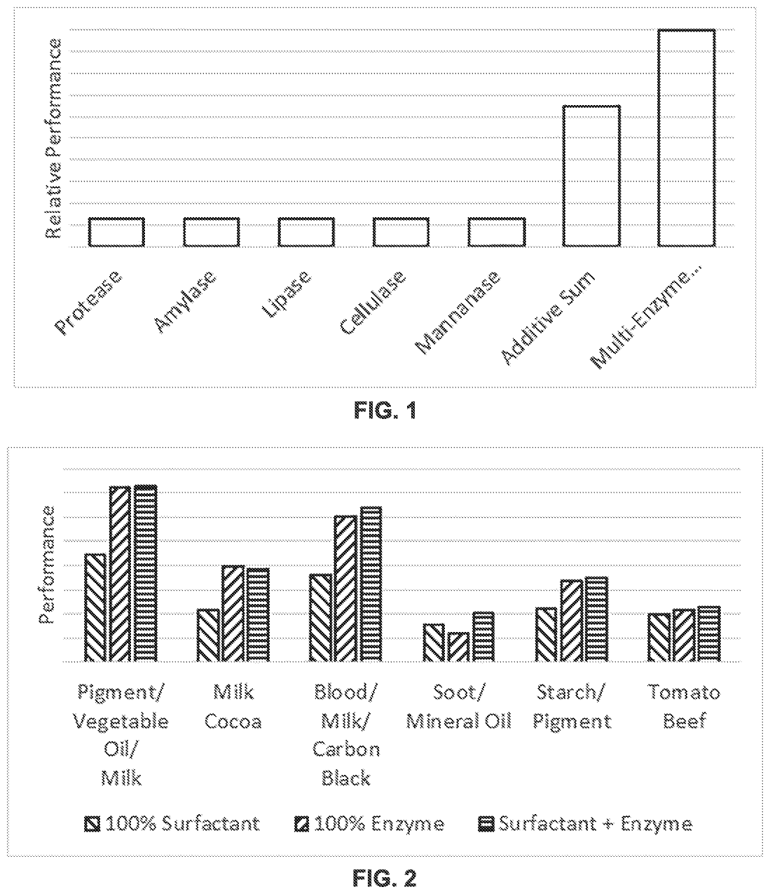

Using the data in Table 1, FIG. 1 shows in a bar chart the relative performance of various enzymes in an institutional laundry, the expected additive relative performance of such enzymes, and the actual relative performance of a combination of the enzymes according to an embodiment of the invention.

TABLE 1
Enzyme Performance

| | Relative |
|---|---|
| Enzyme | Performance, % |
| Protease | 13 |
| Amylase | 13 |
| Lipase | 13 |
| Cellulase | 13 |
| Mannanase | 13 |
| Additive Sum | 65 |
| Multi-Enzyme Solution | 100 |

As shown in Table 1 and FIG. 1, the inventors had conceived that the use of a combination of enzymes in a wash formulation provides and overall relative performance in comparison to the individual performance of each of such enzymes.

TABLE 2
Enzyme and Surfactant Performance

| | 100% | 100% | Surfactant + |
|---|---|---|---|
| Soil | Surfactant | Enzyme | Enzyme |
| Pigment/ | 44.6 | 72.2 | 73.1 |
| Vegetable Oil/ | | | |
| Milk | | | |
| Milk | 21.9 | 39.8 | 38.7 |
| Cocoa | | | |
| Blood/ | 36.3 | 60.2 | 63.7 |
| Milk/ | | | |
| Carbon Black | | | |
| Soot/ | 15.9 | 11.9 | 20.2 |
| Mineral Oil | | | |
| Starch/ | 22.4 | 33.7 | 34.8 |
| Pigment | | | |
| Tomato | 20.0 | 21.5 | 23.0 |
| Beef* | | | |

*Results in testing & evaluation uncertain for this soil.

Table 2 shows cleaning performance for various different soil types of a wash formulation comprising only a surfactant, only an enzyme and a surfactant and an enzyme in combination.

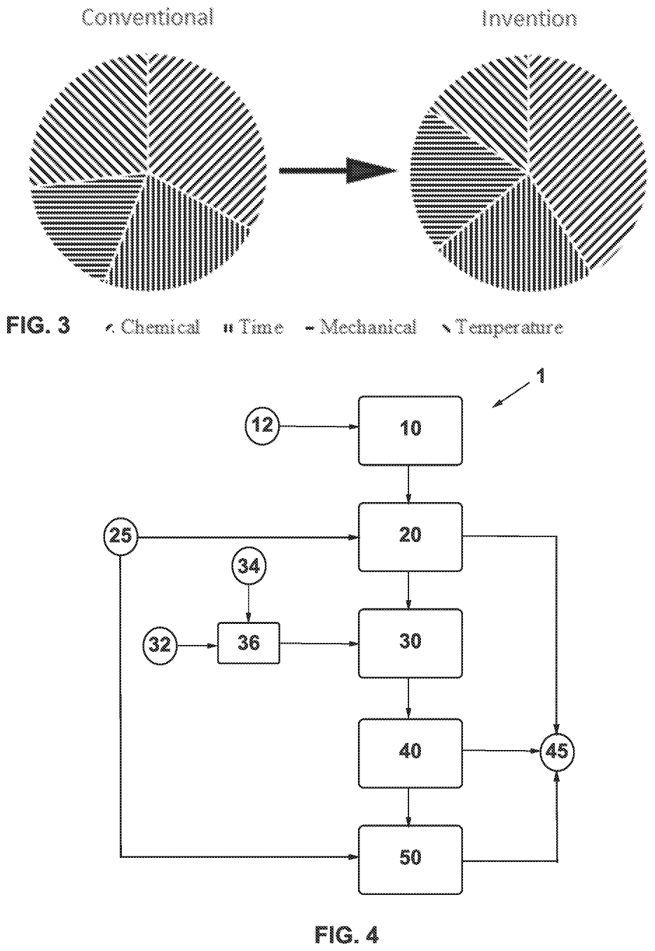

Using the data provided in Table 2, FIG. 2 is a bar chart showing the individual performance for surfactants and enzymes in an institutional laundry and the performance when the surfactants and enzymes are used in combination for varying types of soils according to another embodiment of the invention. The inventors have conceptualized that use of the surfactant(s) and enzyme(s) in combination generally provides a better cleaning performance

As motivated by the conceptualization of the information provided in Table 1, Table 2 and FIGS. 1 and 2 included herein, the inventors have conceptualized, in an embodiment of the invention, a formulation or wash formulation or a prewash formulation as it otherwise may be characterized herein to comprise a surfactant enzyme booster. The surfactant enzyme booster, in certain embodiments of the invention, comprises an enzyme and a surfactant. In an embodiment of the invention, the enzyme may comprise a protease, a lipase, an amylase, a cellulase, a mannanase, a pectinase, a peroxidase, a gluconase, and any combination thereof. In a preferred embodiment of the invention, the enzyme comprises a protease, a lipase, an amylase, a cellulase, a mannanase, a pectinase, and any combination thereof.

In an embodiment of the invention, the surfactant of the prewash formulation may be selected such that the surfactant is are non-polar or hydrophobic in nature, such as nonionic surfactants having no charge, that, while suspended in water, still are attracted to non-water based components that are present in solution. While surfactants may include a combination of polar and non-polar-based surfactants, in preferred embodiments of the invention, the surfactant comprises a nonionic surfactant. Without intending to be bound by the theory, nonionic surfactants provide improved cleaning performance at a temperature that is just below or approaching the cloud point temperature of the nonionic surfactant. In certain embodiments of the invention, without intending to be bound by the theory, the temperature is above the cloud point temperature of the surfactant to prevent foaming of the solution. In certain embodiments of the invention, the nonionic surfactant comprises any one or more of an ethoxylated alcohol generally or an ethoxylated fatty alcohol in a more specific embodiment of the invention. In certain embodiments of the invention, the nonionic surfactant may include, for example, lauryl dimethylamine oxide; a lauryl glucoside; a sucrose-derivative nonionic surfactant, for example, sucrose stearate, sucrose laurate, or sucrose palmitate; a caprylyl glucoside, a capryl glucoside, and/or a caprylyl/capryl glucoside; inulin lauryl carbamate; and a decyl glucoside. In the case of the latter compound, decyl glucoside is produced upon the reaction of glucose from corn starch with the fatty alcohol decanol, which is derived from coconut. In certain embodiments of the invention, the nonionic surfactant may comprise an alkyl polyglucoside. Further pursuant to this embodiment of the invention, the alkyl group of the alkyl polyglucoside comprises, on average, from about 5 to about 10, from about 7 to about 9, or about 8 carbon atoms. A semi-polar nonionic surfactant may comprise, for example, an amine oxide.

In certain embodiments of the invention, the nonionic surfactant comprises an alkyl ethoxylate wherein the alkyl group may be branched and/or unbranched. In a preferred embodiment of the invention, the nonionic surfactant comprises primary and/or secondary alcohol ethoxylates, and in a more preferred embodiment of the invention an alcohol ethoxylate wherein the alcohol comprises, on average, from about 6 to about 21, from about 9 to about 20, from about 10 to about 18 carbon atoms, or from about 11 to about 14 carbon atoms, and the ethoxylate comprises, on average, from about 2 to about 10 or from about 3 to about 7 EOs. In certain embodiments of the invention, the alcohol ethoxylate comprises at least one of a linear alcohol ethoxylate and a branched alcohol ethoxylate. In an embodiment of the invention, the alcohol ethoxylate is C13-rich iso alcohol ethoxylate having an average of about 8 moles of ethylene oxide.

In an embodiment of the invention, the surfactant of the prewash formulation may comprise an anionic surfactant, independent of or in combination with a nonionic surfactant. Anionic surfactants tend to be polar or hydrophilic in nature. In certain embodiments of the invention, the anionic surfactant may comprise a branched modified alkylbenzene sulfonate (MLAS). In certain other embodiments of the invention, the anionic surfactant may comprise a fatty acid or a fatty acid salt. The fatty acids may include carboxylic acids, in particular, those carboxylic acids that have a long unbranched aliphatic tail that can be either saturated or unsaturated. Suitable fatty acids may include ethoxylated fatty acids. Suitable fatty acids or salts of the fatty acids of the present invention may include sodium salts, preferably C12-C18 saturated and/or unsaturated fatty acids more preferably C12-C14 saturated and/or unsaturated fatty acids and alkali or alkali earth metal carbonates preferably sodium carbonate. The anionic surfactants that are fatty acids may be selected from the group consisting of lauric acid, myristic acid, palmitic acid, stearic acid, topped palm kernel fatty acid, coconut fatty acid, any salt thereof, and mixtures thereof. In an embodiment of the invention, the anionic surfactant comprises linear alkylbenzene sulfonate and alkoxylated alkyl sulfate. In certain embodiments of the invention, the anionic surfactant comprises an alkali metal salt of C10-C16 alkyl benzene sulfonic acids, preferably C11-C14 alkyl benzene sulfonic acids. In another embodiment of the invention, the anionic surfactant may comprise ethoxylated alkyl sulfate surfactants such as alkyl ether sulfates or alkyl polyethoxylate sulfates in non-limiting examples. In a preferred embodiment of the invention, the anionic surfactant of the prewash formulation comprises oleic acid, alkylbenzene sulfonic acid, any salt thereof, and any combination thereof.

In an embodiment of the invention, the prewash formulation may comprise at least about 0.000001%, at least about 0.00001%, or at least about 0.0001% of enzyme protein by weight based upon the overall weight of the prewash formulation. In another embodiment of the invention, the prewash formulation may comprise from about 0.01 wt % to about 50 wt %, from about 0.1 wt % to about 30 wt %, from about 0.5 wt % to about 25 wt %, from about 1 wt % to about 20 wt %, or from about 5 wt % to about 15 wt % of surfactant based upon the overall weight of the prewash formulation when included with an enzyme in the prewash formulation.

The formulations and methods herein can be adjusted to provide on the order of from about 1 ppm to about 500 ppm, from about 5 ppm to 250 ppm, from about 10 ppm to about 100 ppm, from about 25 ppm to about 50 ppm, from about 30 ppm to about 45 ppm, or from about 30 ppm to about 40 ppm of the enzyme in the wash solution.

FIG. 3 is a graphical comparison of the resources used in a conventional institutional laundry versus the resources used in an institutional laundry of the invention. As shown in FIG. 3, use of the wash formulations of the invention, as intellectualized by the inventors, provides for a reduced overall energy consumption, while the use of chemicals, although their content has changed; mechanical and time for the cycles support such a reduction in temperature and overall energy use. Such a reduction in energy use is also supported by a reduction in water used in the institutional wash process, as supported by the formulations of the invention.

In an embodiment of the invention, the prewash formulation may comprise an organic solvent. In certain embodiments of the invention, the prewash formulation may additionally comprise a builder, while in certain other embodiments of the invention, the prewash formulation may additionally comprise a detergent either with or without the addition of an organic solvent and/or a builder.

Generally, the organic solvent of the prewash formulation may comprise monoalcohols, polyalcohols, ethers of monoalcohols, ethers of polyalcohols, fatty esters, Guerbet alcohols, isoparaffins, naphthols, glycol ethers, and mixtures thereof. In an embodiment of the invention, the organic solvent of the prewash formulation may comprise propylene glycol, a glycol ether, glycerol, a diol such as a propylene-diol, an organoamine such as an alkanolamine, an alkyl 3-hydroxybutyrate, and any combination thereof. In certain embodiments of the invention, the glycol ether may include glycol monobutyl ether, diethylene glycol monobutyl ether, ethylene glycol monomethyl ether, ethylene glycol monoethyl ether, diethylene glycol monomethyl ether, diethylene glycol monoethyl ether, propylene glycol monobutyl ether, and any mixture thereof. In a preferred embodiment of the invention, the organic solvent of the prewash formulation comprises a glycolic solvent. In certain embodiments of the invention the glycolic solvent comprises propylene glycol, glycerol, and any combination thereof. In certain embodiments of the invention, the organic solvent may comprise butyl diglycol, but may be less preferred in certain embodiments of the invention.

According to an embodiment of the invention, the builder of the prewash formulation may comprise methyl-glycine-diacetic acid, glutamic-N,N-diacetic acid, tetrasodium imminosuccinate, or (hydroxy)iminodisuccinic acid and salts or derivatives thereof. In certain other embodiments of the invention, the builder comprises at least one salt of a hydroxycarboxylic acid selected from hydroxymonocarboxylic acid or hydroxydicarboxylic acid. Builder compounds may include organic molecules containing carboxylic groups such as, in non-limiting examples, citric acid, fumaric acid, tartaric acid, maleic acid, lactic acid and salts thereof. In a particular embodiment of the invention, the alkali or alkaline earth metal salts of the organic builder compounds may be used, especially the salts including sodium salts of such compounds. An especially preferred phosphorous-free builder is sodium citrate. Polycarboxylate builders comprising two carboxyl groups include, for example, water-soluble salts of, malonic acid, (ethylenedioxy)diacetic acid, maleic acid, diglycolic acid, tartaric acid, tartronic acid and fumaric acid. Polycarboxylate builders that contain three carboxyl groups include, for example, water-soluble citrate. Correspondingly, a suitable hydroxycarboxylic acid is, for example, citric acid. In one preferred embodiment of the invention, the builder of the prewash formulation comprises a polyphosphate salt. In another particular embodiment of the invention, the builder of the prewash formulation is phosphorous-free and comprises non-polymeric organic molecules having one or more carboxylic groups.

In an embodiment of the invention, the detergent of the prewash formulation is selected to allow low temperature cleaning. Indeed, any surfactant or combination of surfactants that allow low temperature cleaning of fabrics in an institutional laundry are preferred. In a non-limiting example, such a detergent that allows low temperature cleaning may comprise a lipase and a mid-chain headgroup surfactant or an alkylene-bridged surfactant. In other embodiments of the invention, the detergent comprises alkyl sulfate, a fatty acid alkanolamide, a fatty acid amidoamine, and any combination thereof. In a preferred embodiment of the invention, the detergent may comprise an enzyme, such as, in a non-limiting example, a polypeptide consisting of an amino acid sequence. Other examples of detergents that may prove useful in a prewash formulation include a sodium lauryl ether sulfate, an alkylbenzene sulfonate including either or both of linear and branched alkylbenzene sulfonates, lauramidopropyl betaine, an alkali metal silicate, and a polymer having maleic acid, vinyl acetate and alkyl acrylate monomers. In a particulate embodiment of the invention, the detergent is substantially free of a phosphorous.

In an embodiment of the invention, the prewash formulation may comprise from about 0.01 wt % to about 50 wt %, from about 0.1 wt % to about 30 wt %, from about 1 wt % to about 25 wt %, from about 3 wt % to about 20 wt %, from about 5 wt % to about 15 wt %, or from about 8 wt % to about 10 wt % of the organic solvent based upon the overall weight of the prewash formulation. In certain embodiments of the invention, the prewash formulation comprises from about 0.01 wt % to about 50 wt %, from about 0.1 wt % to about 30 wt %, from about 1 wt % to about 25 wt %, or from about 3 wt % to about 20 wt % of a builder based upon the overall weight of the prewash formulation. In other embodiments of the invention, the prewash formulation comprises from about 0.01 wt % to about 15 wt %, from about 0.1 wt % to about 12 wt %, from about 0.5 wt % to about 10 wt %, or from about 1 wt % to about 5 wt % of a bleach based upon the overall weight of the prewash formulation.

In another embodiment of the invention, the prewash formulation may include a polymer, in particular a soil-suspending polymer, to assist with keeping any particulate soils in the wash water. Such polymers may also be generally characterized as anti-redeposition agents in the prewash cycle. In an embodiment of the invention, the prewash formulation may comprise up to about 6 wt % of anti-redeposition agents, from about 0.5 wt % to about 5 wt %, or from about 1 wt % to about 3 wt % of anti-redeposition agents based upon the overall weight of the prewash formulation.

The prewash formulations of the invention can be metered or batch-filled into a commercial or industrial or institutional laundry machine such as a tunnel washing machine in a nonlimiting example. A concentration of the prewash formulation in a prewash cycle may be from about 0.1 wt % to about 10 wt %, from about 0.5 wt % to about 7 wt %, or from about 1 wt % to about 6 wt % in the solution used in the prewash cycle of the washer. The garments or fabric are typically treated in the prewash cycle anywhere from ambient to an elevated temperature. In an embodiment of the invention, the temperature of the prewash cycle is from about ambient to about 50° C., from about ambient to about 40° C., from about 20° C. to about 30° C., from about 22° C. to about 30° C., from about 20° C. to 25° C., or about 20° C.

Depending on the concentration of the prewash formulation used, the prewash cycle can be from about 10 seconds to about 1200 seconds, from about 10 seconds to about 600 seconds, or from about 20 to about 300 seconds. The prewash cycle may include agitation of composition with the clothing. In certain embodiments of the invention, the prewash formulation in liquid form, optionally, in combination with an included solvent, may be sprayed or physically contacted with the soiled item. In another embodiment of the invention, the prewash formulation of the invention may be in the form of a solid and the solid block or stick may be directly contacted with the stain or spot leaving the solid formulation in the form of a thin film or residue substantially covering the entirety of any spot or stain on the garment. The pre-treated garment can be left to permit the surfactant compositions of the formulation to associate with the stain to pre-treat the stain or spot outside the institutional washing machine. However, the pre-treated garment or fabric can be immediately introduced into a prewash or pre-treatment cycle or stage of the institutional washer. The washing machine can, at this time, contain a diluent, such as an aqueous diluent for example, that can aid in pre-treating the soiled items. Optionally, the items may be introduced into the washing machine without any diluents to permit the prewash formulation to complete pre-treating the soil prior to a laundry wash step.

In certain embodiments of the invention, LEVITT® integrate 100 L (product of Novozymes A/S) provides the surfactant and the enzyme of the prewash formulation.

In an embodiment of the invention, the prewash formulation for a non-phosphate based treatment formulation comprises from about 0.5 wt % to about 10 wt % of LEVITI integrate 100 L or a similar enzyme equivalent; from about 10 wt % to about 55 wt % of a nonionic surfactant; from about 1 wt % to about 10 wt % of an anionic surfactant; from about 0.001 wt % to about 0.008 wt % of an antimicrobial; from about 3 wt % to about 18 wt % of an organic solvent; and from about 20 wt % to about 60 wt % of a solvent, in particular, an aqueous based solvent.

In a preferred embodiment of the invention, the prewash formulation for a non-phosphate based treatment formulation comprises from about 0.5 wt % to about 4.4 wt % of LEVITI integrate 100 L or a similar enzyme equivalent; from about 25.1 wt % to about 54.80 wt % of a nonionic surfactant that may comprise any one or combination of alcohol (C13-16) ethoxylate (7EO), isoalcohol (C13) ethoxylate (3EO), and 4,4′-distyryl biphenyl derivative (DSBP); from about 1 wt % to about 4 wt % of an anionic surfactant that may include sodium cumene sulfonate (SCS); from about 0.001 wt % to about 0.008 wt % of an antimicrobial that may include dispropylene glycol solution of 1,2-benzisothiazolin-3-one; from about 3 wt % to about 18 wt % of an organic solvent that may include a glycolic solvent as further defined herein; and from about 20 wt % to about 60 wt % of a solvent, in particular, an aqueous based solvent such as water for instance.

In an embodiment of the invention, the prewash formulation for a phosphate based treatment formulation comprises from about 0.5 wt % to about 2.5 wt % of LEVITI integrate 100 L or a similar enzyme equivalent; from about 1.5 wt % to about 4.0 wt % of a nonionic surfactant; from about 4.01 wt % to about 8.099 wt % of an anionic surfactant; from about 0.005 wt % to about 0.030 wt % of an antimicrobial; from about 0.10 wt % to about 0.40 wt % of a chelating agent; from about 17 wt % to about 23 wt % of a builder; from about 0.2 wt % to about 1 wt % of an alkali agent; from about 0.02 wt % to about 0.1 wt % of a whitening agent; from about 0.1 wt % to about 0.8 wt % of a foam control agent; optionally, from about 0.05 wt % to about 0.5 wt % of a perfume; from about 0.5 wt % to about 1.8 wt % of an enzyme; from about 0.1 wt % to about 0.99 wt % of an enzyme stabilizer; from about 3 wt % to about 10 wt % of an organic solvent; and from about 50 wt % to about 70 wt % of a solvent, in particular, an aqueous based solvent.

In a preferred embodiment of the invention, the prewash formulation for a phosphate based treatment formulation comprises from about 0.5 wt % to about 2.0 wt % of LEVITI integrate 100 L or a similar enzyme equivalent; from about 1.5 wt % to about 4.0 wt % of a nonionic surfactant that may include alcohol (C13-16) ethoxylate (7EO); from about 4.01 wt % to about 8.099 wt % of an anionic surfactant that may comprise any one or combination of alkyl benzene sulfonic acid and sodium cumene sulfonate (SCS); from about 0.005 wt % to about 0.030 wt % of an antimicrobial that may include dispropylene glycol solution of 1,2-benzisothiazolin-3-one; from about 0.10 wt % to about 0.40 wt % of a chelating agent that may comprise any one of or any combination of a low molecular weight poly(acrylic acid) homopolymer and a low molecular weight polymer vinylpyrrolidone & vinylimidazole copolymer; from about 17 wt % to about 23 wt % of a builder that may include sodium triphosphate; from about 0.2 wt % to about 1 wt % of an alkali that may include sodium hydroxide; from about 0.02 wt % to about 0.1 wt % of a whitening agent that may include distyryl-biphenyl derivate; from about 0.1 wt % to about 0.8 wt % of a foam control agent that may include polydimethylsiloxane; optionally, from about 0.05 wt % to about 0.5 wt % of a perfume; from about 0.10 wt % to about 0.99 wt % of an enzyme stabilizer that may comprise one or a combination of calcium chloride dihydrate and sodium formate; from about 3 wt % to about 10 wt % of an organic solvent that may include a glycolic solvent as further defined herein; and from about 50 wt % to about 70 wt % of a solvent, in particular, an aqueous based solvent such as water for instance.

In an embodiment of the invention, a formulation is provided that may be used in a wash phase of an institutional laundry. In certain embodiments of the invention, such a formulation or a wash formulation or a main wash formulation as it may otherwise be characterized herein comprises a bleach and a bleach enhancer. In another embodiment of the invention, the wash formulation may include a chelating agent. In still other embodiments of the invention the wash formulation may comprise an anti-redeposition agent and/or a soil suspension agent. In certain embodiments of the invention, the wash formulation comprises a surfactant. Further pursuant to this embodiment of the invention, the surfactant may comprise a nonionic surfactant, an anionic surfactant, and a combination thereof. In other embodiments of the invention, the wash formulation comprises a solvent. Further pursuant to this embodiment of the invention, the solvent may comprise water, an aqueous based solvent, an organic solvent and any combination thereof. In still other embodiments of the invention, the wash formulation comprises an alkali. Without intending to be bound by the theory, an alkali may provide the needed pH control of the wash solution.

A bleach suitable for use in the invention includes a source of hydrogen peroxide, pre-formed peracids, available oxygen, chlorine, and any combination thereof. Suitable sources of hydrogen peroxide include sodium perborate and/or sodium percarbonate as non-limiting examples. In a preferred embodiment of the invention, the bleach may comprise any one or more of hydrogen peroxide (H₂O₂), peracetic acid (PAA), chlorine, and a phthalimido peroxy alkanoic acid (PAP). In certain embodiments of the invention, a pH of the wash solution will vary depending, for example, upon the type of bleach being used in the wash formulation. In certain embodiments of the invention, the pH of a wash solution is from about 11 to about 12 when the bleach agent includes hydrogen peroxide, from about 9 to about 9.5 when the bleach agent includes peracetic acid, from about 9 to about 10 when the bleach agent includes chlorine, and from about 8.5 to about 9 when the bleach agent includes peroxy phthalimido alkanoic acid.

The formulations and methods herein can be adjusted to provide on the order of at least one part per hundred million of the active bleach enhancer in the wash composition, from about 1 ppm to 1000 ppm, from about 25 ppm to about 500 ppm, from about 50 ppm to about 375 ppm, from about 100 ppm to about 300 ppm, or from about 120 ppm to about 250 ppm of the bleach in the wash solution.

According to an embodiment of the invention, bleach enhancers may be selected from the group consisting of tetraacetyl ethylene diamine (TAED), benzoylcaprolactam (BzCL), 4 nitrobenzoylcaprolactam, 3-chlorobenzoylcaprolactam, benzoyloxybenzenesulphonate (BOBS), nonanoyloxybenzenesulphonate (NOBS), phenyl benzoate (PhBz), decanoyloxybenzenesulphonate (C10-OBS), benzoylvalerolactam (BZVL), octanoyloxybenzenesulphonate (C8-OBS), perhydrolyzable esters and mixtures thereof, most preferably benzoylcaprolactam and benzoylvalerolactam. Bleach enhancers may also include hydrophobic actives that may include, but are not limited to, nonanoyloxybenzenesulphonate (NOBS), 4-[N-(nonaoyl) amino hexanoyloxy]-benzene sulfonate sodium salt (NACA-OBS), dodecanoyloxybenzenesulphonate (LOBS or C12-OBS), 10-undecenoyloxybenzenesulfonate (UDOBS or C11-OBS with unsaturation in the 10 position), and decanoyloxybenzoic acid (DOBA). Quaternary substituted bleach enhancers may also be included. Other examples of bleach enhancers include (6-octanamidocaproyl)oxyb enzenesulfonate, (6-nonanamidocaproyl) oxybenzenesulfonate, (6-decanamidocaproyl)oxybenzenesulfonate and mixtures thereof. Benzoxazin-type enhancers, such as a C6H4 ring to which is fused in the 1,2-positions a moiety —C(O)OC(R1)=N—may be included as well. Nitriles, such as acetonitriles and/or ammonium nitrites and other quaternary nitrogen containing nitrites, are another class of enhancers that may be useful herein. Acyl lactam enhancers may be useful as well, in particular, for example, the acyl caprolactams and acyl valerolactams. Metal-containing bleach catalysts, preferably manganese and cobalt-containing bleach catalysts may serve as enhancers of the invention. One type of metal-containing bleach catalyst is a catalyst system comprising a transition metal cation of defined bleach catalytic activity, such as copper, iron, titanium, ruthenium tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methylenephosphonic acid) and water-soluble salts thereof. Manganese metal complexes and cobalt metal complexes may also be used as bleach enhancers. Examples of such enhancers include MnIV2(u-O)3(1,4,7-trimethyl-1,4,7-triazacyclononane)2(PF6)2, MnIII2(u-O)1(u-OAc)2(1,4,7-trimethyl-1,4,7-triazacyclononane)2(C104)2, MnIV4(u-O)6(1,4,7-triazacyclononane)4(C104)4, MnIII-MnIV4(u-O)1(u-OAC)2-(1,4,7-trimethyl-1,4,7-triazacyclononane)2(C104)3, MnIV(1,4,7-trimethyl-1,4,7-triazacyclononane)-(OCH3)3(PF6), cobalt pentaamine acetate chloride, [Co(NH3)5OAc]Cl2; as well as [Co(NH3)5OAc](OAc)2; [Co(NH3)5OAc](PF6)2; [Co(NH3)5OAc](SO4); [Co(NH3)5OAc](BF4)2; and [Co(NH3)5OAc](NO3)2 (herein “PAC”); and mixtures thereof. Transition metal complexes of a macropolycyclic rigid ligand may also serve as a bleach enhancer, for example, without intending to be limiting dichloro-5,12-dimethyl-1,5,8,12-tetraazabicyclo[6.6.2]hexadecane manganese(II), dichloro-5,12-diethyl-1,5,8,12-tetraazabicyclo[6.6.2]hexadecane manganese(II), and diaquo-5,12-dimethyl-1,5,8,12-tetraazabicyclo[6.6.2]hexadecane manganese(II) hexafluorophosphate.

In a preferred embodiment of the invention, the bleach enhancer of the invention may include citric acid (e.g., present as sodium citrate in formula), sodium and/or potassium persulfate, potassium permanganate, manganese gluconate, a laccase enzyme, and any combination thereof. Further pursuant to this preferred embodiment of the invention,

As a practical matter, and not by way of limitation, the formulations and methods herein can be adjusted to provide on the order of at least one part per hundred million of the active bleach enhancer in the wash composition, from about 0.01 ppm to 1000 ppm, from about 1 ppm to about 500 ppm, from about 25 ppm to about 375 ppm, from about 50 ppm to about 300 ppm, from about 180 ppm to about 240 ppm or from about 130 ppm to about 150 ppm of the bleach enhancer in the wash solution.

An anti-redeposition agent of the invention may include a fatty acid amide, a fluorocarbon surfactant, a complex phosphate ester, a styrene maleic anhydride copolymer, and a cellulosic derivative such as hydroxyethyl cellulose, hydroxypropyl cellulose, and the like. A use solution can include 0.005-10 wt %, or 0.1-5 wt %, of an anti-redeposition agent. In a preferred embodiment of the invention, the anti-redeposition agent of the invention comprises a carboxymethyl cellulose salt, such as a carboxymethyl cellulose sodium salt, or more generally a carboxymethyl cellulose (CMC).

The formulations and methods of the invention can be adjusted to provide from about 0.1 ppm to 500 ppm, from about 1 ppm to about 250 ppm, from about 5 ppm to about 100 ppm, from about 5 ppm to about 50 ppm, from about 10 ppm to about 20 ppm or from about 10 ppm to about 14 ppm of the anti-redeposition agent in the wash solution.

Non-limiting examples of chelating agents that may be included in the formulation of the invention are ethylenediaminetetraacetic acid (EDTA) and any salt thereof, (hydroxyethyl)ethylenediaminetriacetic acid (HEDTA) and any salt thereof, potassium tripolyphosphate (KTPP), a phosphonic acid and any salt thereof, nitrilotriacetic acid (NTA) and any salt thereof, diethylene triamine pentaacetic acid (DTPA) and any salt thereof, gluconic acid (GA) and any salt thereof, glutamic acid diacetic acid (GLDA) and any salt thereof, methylglycinediacetic acid (MGDA) and any salt thereof, iminodisuccinc acid (IDS) and any salt thereof, aminocarboxylic acids and any salt thereof, hydroxyethane diphosphonic acid (HEDP) and any salt thereof, aminotris(methylenephosphonic acid) (ATMP) and any salt thereof, 2-phosphonobutane-1,2,4-tricarboxylic acid (PBTC) and any salt thereof, ethylenediamine tetra(methylene phosphonic acid) (EDTMP) and any salt thereof, diethylenetriamine penta(methylene phosphonic acid) (DTPMP) and any salt thereof, a polyacrylate, sodium gluconate (Na-gluconate) and any combinations thereof. In a preferred embodiment of the invention, a chelant, chelating agent, or sequestrant may comprise methylglycinediacetic acid (MGDA) and any salt and derivative thereof, a poly(acrylic acid), more preferably, a low molecular weight poly(acrylic acid) homopolymer, and any combination thereof. A commercial formulation SOKALAN® PA 25 CL PN (a product of BASF based in based in Ludwigshafen, Germany) may provide the poly(acrylic acid) of the formulation.

The formulations and methods of the invention can be adjusted to provide from about 10 ppm to about 500 ppm, from about 25 ppm to about 250 ppm, from about 50 ppm to about 200 ppm, from about 75 ppm to about 150 ppm, from about 45 ppm to about 75 ppm, or from about 95 ppm to about 130 ppm of the chelant or the chelating agent in the wash solution.

Formulations of the invention may comprise, for example, nonionic surfactants that include polyoxyethylene alkyl ethers, polyethylene alkylphenyl ethers, polyethylene fatty acid esters, sorbitan fatty acid esters, polyethylene sorbitan fatty acid esters, sugar esters of fatty acids, alkyl polyglycosides, fatty acid diethanolamides, fatty acid monoglycerides, alkylmonoglyceral ethers, fatty acid polypropyleneglycol esters and the like. In a preferred embodiment of the invention, nonionic surfactants comprise isoalcohol ethoxylate, particularly, an isoalcohol having an average carbon content from about C11 to about C15, from about C12 to about C14, or about C13 and an ethoxylate having on average from about 1EO to about 5EO, from about 2EO to about 4EO, or about 3EO; 4,4′-distyryl biphenyl derivative (DSBP), and any combination thereof.

Without intending to be limiting, the formulations and methods herein can be adjusted to provide on the order of from about 1 ppm to about 1000 ppm, from about 5 ppm to about 500 ppm, from about 10 ppm to about 350 ppm, from about 50 ppm to about 300 ppm, from about 180 ppm to about 220 ppm, from about 240 ppm to about 300 ppm or from about 50 ppm to about 60 ppm of the nonionic surfactant in the wash solution.

Anionic surfactants of the invention may include fatty acid soaps covering a range of alkyl chain length, for example up to about 18 carbon atoms, and may be straight or branched chain alkyl groups. Another class of anionic surfactants includes alkyl sulfates and sulfonates, such as SDS. Another useful anionic surfactant may be based on alkylpolyoxyethylene sulfate. Another anionic surfactant that can be used is an alkylbenzene sulfonate. Linear and branched chain alkylbenzene sulfates with one or more sulfonate groups have been found to be useful in the formulations of the invention. Suitable anionic surfactants also include alpha-olefin sulfonates, monoalkyl phosphates, acyl isothionates, acyl glutamates, N-acyl sarcosinates and alkenyl succinates and the like that have an anionic surface group and possess surface activity. In a preferred embodiment of the invention, anionic surfactants comprise oleic acid salt; sodium salt of alkylbenzene sulfonic acid; a cumene sulfonate salt, for example, sodium cumene sulfonate (SCS); and combinations thereof.

Without intending to be limiting, the formulations and methods herein can be adjusted to provide on the order of from about 1 ppm to about 500 ppm, from about 5 ppm to about 250 ppm, from about 10 ppm to about 100 ppm, from about 25 ppm to about 75 ppm or from about 50 ppm to about 60 ppm of the anionic surfactant in the wash solution.

The formulation of the invention may comprise an organic solvent. In an embodiment of the invention, the organic solvent may be a nonpolar solvent, a protic polar solvent, an aprotic polar solvent, or a combination thereof. Non-limiting examples of nonpolar solvents may include benzene, chlorobenzene, fluorobenzene, butyl acetate, tert-butyl methyl ether, chloroform, chloromethane, cyclohexane, dichloromethane (DCM), dichloroethane, di-tert-butyl ether, dimethyl ether, diethylene glycol, diethyl ether, diglyme, diisopropyl ether, ethyl tert-butyl ether, ethylene oxide, heptane, hexane, methyl tert-butyl ether, toluene, and combinations thereof. Suitable protic polar solvents include without limitation amides such as formamide, acetamide, and the like. Non-limiting examples of aprotic polar solvents include acetone, acetonitrile, diethoxymethane, N,N-dimethylformamide (DMF), dimethyl sulfoxide (DMSO), N,N-dimethylpropionamide, 1,3-dimethyl-3,4,5,6-tetrahydro-2(1H)-pyrimidinone (DMPU), 1,3-dimethyl-2-imidazolidinone (DMI), 1,2-dimethoxyethane (DME), dimethoxymethane, bis(2-methoxyethyl)ether, N,N-dimethylacetamide (DMAC), N-methyl-2-pyrrolidinone (NMP), 1,4-dioxane, ethyl acetate, ethyl formate, formamide, hexachloroacetone, hexamethylphosphoramide, methyl acetate, N-methylacetamide, methylethyl ketone, methylisobutyl ketone, N-methylformamide, methylene chloride, methoxyethane, morpholine, nitrobenzene, nitromethane, propionitrile, propyl acetates, sulfolane, tetramethylurea, tetrahydrofuran (THF), 2-methyl tetrahydrofuran, tetrahydropyran, trichloromethane, and combinations thereof. In certain embodiments of the invention, the organic solvent may be toluene. In a preferred embodiment of the invention, the organic solvent comprises a glycolic solvent. Further pursuant to this embodiment of the invention the glycolic solvent may comprise propylene glycol, glycerol, and any combination thereof, according to an embodiment.

In an embodiment of the invention, the formulations and methods of the invention can be adjusted to provide on the order of from about 1 ppm to about 1000 ppm, from about 10 ppm to about 500 ppm, from about 25 ppm to about 250 ppm, from about 50 ppm to about 200 ppm, from about 75 ppm to about 175 ppm, from about 80 ppm to about 120 ppm, from about 100 ppm to about 150 ppm or from about 80 ppm to about 150 ppm of the organic solvent in the wash solution.

The formulation of the invention may comprise an aqueous solvent. For example, the formulation of the invention may comprise water.

In certain embodiments of the invention, the main wash formulation additionally comprises a builder. Further pursuant to this embodiment of the invention, the builder comprises a vinylpyrrolidone and vinylimidazole copolymer, an acrylic acid homopolymer, a double salt of potassium sulfate and aluminum sulfate, a mixture of an aromatic polyester and a zeolite, a vinylpyrrolidone polymer, and any combination thereof.

In an embodiment of the invention, the wash formulation may be used without first using the prewash formulation as further disclosed herein. In another embodiment of the invention, the prewash formulation may be used without the wash formulation as further disclosed herein. In a preferred embodiment of the invention, both the prewash formulation and wash formulation as further disclosed herein are both used in the institutional laundry.

In certain embodiments of the invention, the prewash formulation may have from about 0.1 ml to about 100 ml per kilogram of textiles, from about 0.5 ml to about 50 ml per kilogram of textiles, from about 1 ml to about 25 ml per kilogram of textiles, or from about 2 ml to about 10 ml per kilogram of textiles. In certain other embodiments of the invention, the non-phosphate based prewash formulation may have from about 0.1 ml to about 50 ml per kilogram of textiles, from about 0.5 ml to about 25 ml per kilogram of textiles, from about 1 ml to about 15 ml per kilogram of textiles, or from about 2 ml to about 5 ml per kilogram of textiles. In still certain other embodiments of the invention, the phosphate based prewash formulation may have from about 0.1 ml to about 100 ml per kilogram of textiles, from about 1 ml to about 50 ml per kilogram of textiles, from about 2 ml to about 20 ml per kilogram of textiles, from about 5 ml to about 15 ml per kilogram of textiles, or about 10 ml per kilogram of textiles

In certain embodiments of the invention, the builder of the main formulation may have from about 0.1 ml to about 100 ml per kilogram of textiles, from about 1 ml to about 25 ml per kilogram of textiles, from about 2 ml to about 20 ml per kilogram of textiles, or from about 3 ml to about 12 ml per kilogram of textiles. In certain other embodiments of the invention, the non-phosphate based main wash formulation may have from about 0.1 ml to about 50 ml per kilogram of textiles, from about 1 ml to about 20 ml per kilogram of textiles, from about 5 ml to about 15 ml per kilogram of textiles, or from about 8 ml to about 12 ml per kilogram of textiles. In still certain other embodiments of the invention, the phosphate based main wash formulation may have from about 0.1 ml to about 50 ml per kilogram of textiles, from about 1 ml to about 20 ml per kilogram of textiles, from about 2 ml to about 10 ml per kilogram of textiles, or from about 3 ml to about 5 ml per kilogram of textiles

In certain embodiments of the invention, the condensed bleach of the treatment formulations may have from about 0.1 ml to about 25 ml per kilogram of textiles, from about 1 ml to about 15 ml per kilogram of textiles, from about 2 ml to about 10 ml per kilogram of textiles, or from about 3 ml to about 5 ml per kilogram of textiles.

In an embodiment of the invention, the main wash formulation for the non-phosphate based system comprises from about 0 wt % to about 12 wt % of a bleach enhancer, from about 0.2 wt % to about 0.9 wt % of an anti-redeposition agent; from about 1.8 wt % to about 36 wt % of a chelating agent; from about 1 wt % to about 9.5 wt % of an anionic surfactant; optionally, from about 0.5 wt % to about 1.8 wt % of an enzyme; from about 1 wt % to about 5 wt % of an organic solvent; from about 8.7 wt % to about 38 wt % of an alkali agent; and from about 45 wt % to about 78 wt % of a solvent, in particular, an aqueous based solvent.

In a preferred embodiment of the invention, the main wash formulation for the non-phosphate based system comprises from about 5 wt % to about 12 wt % of a bleach enhancer that may include citric acid 1H₂O, from about 0.2 wt % to about 0.7 wt % of an anti-redeposition agent that may include carboxy methyl cellulose (CMC); from about 1.8 wt % to about 6.1 wt % of a chelating agent that may comprise any one or combination of methylglycinediacetic acid (MGDA) and low molecular weight poly(acrylic acid) homopolymer; from about 2.8 wt % to about 9.5 wt % of an anionic surfactant that may comprise any one or combination of linear alkyl benzene sulfonic acid (LABSA), oleic acid and sodium cumene sulfonate (SCS); from about 1 wt % to about 5 wt % of an organic solvent that may include a glycerol solvent as further defined herein; from about 8.7 wt % to about 15 wt % of an alkali that may include sodium hydroxide; and from about 60 wt % to about 78 wt % of a solvent, in particular, an aqueous based solvent that may include water.

In an embodiment of the invention, the main wash formulation for the phosphate based system comprises from about 8 wt % to about 12 wt % of a bleach enhancer that may include citric acid 1H₂O, from about 0.6 wt % to about 1.2 wt % of an anti-redeposition agent that may include carboxy methyl cellulose (CMC); optionally, from about 0.1 wt % to about 0.3 wt % of an anionic surfactant; from about 4 wt % to about 12 wt % of an alkali that may include sodium hydroxide; and from about 75 wt % to about 85 wt % of a solvent, in particular, an aqueous based solvent that may include water.

In a preferred embodiment of the invention, the main wash formulation for the phosphate based system comprises from about 8 wt % to about 12 wt % of a bleach enhancer that may include citric acid 1H₂O, from about 0.6 wt % to about 1.2 wt % of an anti-redeposition agent that may include carboxy methyl cellulose (CMC); from about 4 wt % to about 12 wt % of an alkali that may include sodium hydroxide; and from about 75 wt % to about 85 wt % of a solvent, in particular, an aqueous based solvent that may include water.

In another aspect, the invention provides a method for reducing institutional and water use in an institutional laundry.

FIG. 4 provides a process flow diagram of a conventional method of washing a fabric in an institutional laundry. This exemplary conventional method of washing a fabric in an institutional laundry 1 includes a fabric pre-treatment 10 where a pretreatment concentrate 15 may be introduced. The pretreated fabric is then introduced to first rinse and decant cycle 20 where a rinse solution 25, typically water or an aqueous-based solvent, is added to remove any remaining and spent pretreatment concentrate 15 from the fabric. The “dirty” rinse solution id decanted 45 from the process. The fabric is then introduced to one or more wash cycles 30 where a wash detergent 34 is combined with a solvent 32, for example water or an aqueous-based solvent, and mixed in a wash solution mixer 36 prior to being introduced to the process for any wash cycle 30. Following completion of the wash cycles 30, the wash solution having the solvent and any spent or remaining detergent concentrate is subjected to a drain cycle 40 where said solution is decanted 45 from the process. The fabric is then subjected to at least one other rinse cycle 50 after which the “dirty” rinse solution(s) is/are decanted 45 from the process.

The conventional method of washing a fabric in an institutional laundry is energy intensive where the wash cycles 45 are operated at a temperature in a range of from about 50° C. to about 80° C. and water intensive since there are at least two rinse cycles 20, 50 that are required.

The general structure of a fabric material treatment system for washing a fabric in an institutional laundry typically includes a chamber for washing a fabric material having a washing zone and a treatment zone downstream from the washing zone, a reservoir for the wash solution, where the reservoir feeds the wash solution to the chamber, and a pump connected to the reservoir and the treatment zone to inject the wash solution from the reservoir into the treatment zone. In some cases, the chamber can be configured as a laundry wash tunnel. The system may also include digitized controls for controlling the introduction of the wash system, times of wash and rinse cycles, and maintaining the temperatures that the wash system must be operated at.

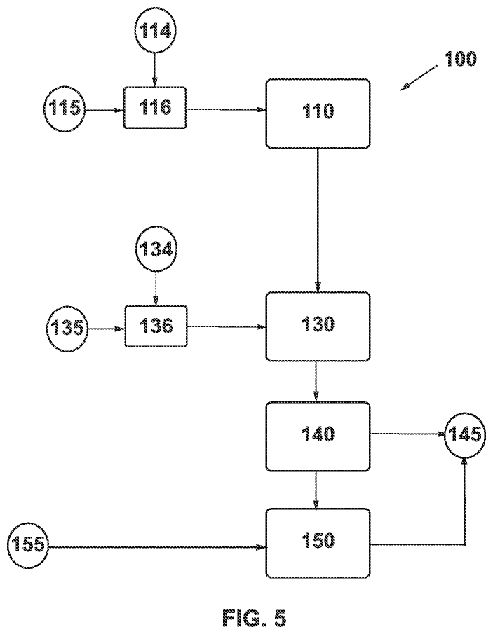

FIG. 5 is a process flow diagram of a method for washing a fabric in an institutional laundry according to an embodiment of the invention. The method of washing a fabric in an institutional laundry 100 of FIG. 5 includes a prewash 110. According to this exemplary embodiment, the prewash formulation 115 is mixed with a solvent 114, typically an aqueous-based solvent, in a prewash mixer 116 to form a prewash solution prior to being introduced to the process for prewash 110. In another embodiment of the invention, the prewash solution may be fed directly to the prewash 110. According to the exemplary embodiment of FIG. 5, a solvent 134, an aqueous solvent in some instances, is mixed with a main wash formulation 135 in a main wash mixer 136 to form the main wash solution that is introduced to the main wash 130. A novel feature of this exemplary embodiment of FIG. 5 over the conventional process of FIG. 4 is that a rinse is not needed between the prewash 110 and main wash 130 stages. In another embodiment of the invention, a rinse cycle having only a small amount of use of water may be included between the prewash and main wash stages. Following completion of the main wash 130, the wash solution is subjected to a drain and/or extract 140 where main wash solution free or that can be freed from the fabric is decanted 145. Following the drain and/or extract 140, the fabric is this subjected to a rinse 150 where a rinse solution 155 is introduced to the fabric followed by being decanted 145 from the process.

The amount of energy required by the inventive exemplary process of FIG. 5 is reduced over that required in the conventional process of FIG. 4 since the prewash 110 and the main wash 130 only operate at about or no more than about 20° C. Also, the amount of solvent or aqueous-based rinse water is also reduced since the inventive process of FIG. 5 is subjected to only one rinse 150.

In yet another aspect, the invention provides a system that reduces energy and water use in an institutional laundry. A system for cleaning a fabric in an institutional laundry machine including a prewash stage where a surfactant enzyme booster formulation is introduced to a wash solution of the fabric; a main wash stage where a detergent formulation is introduced to the wash solution; at least one of a drain and an extraction stage for the wash solution where any remaining and spent surfactant enzyme booster formulation and detergent formulation are removed from the fabric; and a rinse stage where an aqueous solution rinses the fabric. In an embodiment of the invention, a temperature in the institutional laundry machine during each stage does not exceed about 20° C. Indeed, any formulation and/or method of the invention as further disclosed herein may be included in any system for reducing the energy and water usage in an institutional laundry.

In certain embodiments of the invention, the surfactant enzyme booster formulation comprises an enzyme; and a surfactant. In certain embodiments of the invention, a pH of the prewash stage is about 7.

In certain embodiment of the invention, the detergent formulation for the system includes a bleach agent; a bleach enhancer; a chelate agent; an anti-redeposition agent; and a builder.

Furthermore, the system of the invention may have a main wash stage that comprises a first stage where a portion of the detergent formulation is used to raise a pH of the wash solution anywhere in a range of from about 7 to about 9, and a second stage where a remainder of the detergent formulation and a bleach agent is added to the wash solution.

In certain embodiments of the invention, the bleach agent substantially inactivates any active enzymes remaining in the wash solution.

### EXAMPLES

The invention is further defined by reference to the following examples, which describe and shows the results for certain institutional laundry formulations and methods of the invention. The performance of such formulations and methods as had been determined is shown in these examples.

### Example 1

Table 3A shows the combination of the surfactant enzyme booster, builder and bleach for non-phosphate based institutional laundry formulations according to an embodiment of the invention.

TABLE 3A

| | Non-Phosphate Based Institutional | Concentration | |
|---|---|---|---|
| | Laundry Formulations | Range | |
| 1 | Surfactant enzyme booster Non Phosphate-based | 2-5 | mL/kg |
| 2 | Builder A | 8-12 | mL/kg |
| 3 | Bleach- conventional | 3-5 | mL/kg |

Table 3B shows the surfactant enzyme booster combination for the non-phosphate based institutional laundry formulation of this example.

TABLE 3B
Surfactant Enzyme Booster Formulation
Non-Phosphate Based

| | | Concentration, |
|---|---|---|
| Compound | Function | wt % |
| LEVITI ® Integrate 100 L | Enzyme | 0.50-4.40 |
| Alcohol (C13-16) Ethoxylate | Nonionic | 20.00-40.00 |
| (7EO) | Surfactant | |
| Isoalcohol (C13) Ethoxylate | Nonionic | 5.00-14.00 |
| (3EO) | Surfactant | |
| 4.4′-Distyryl Biphenyl | Nonionic | 0.10-0.80 |
| Derivative (DSBP) | Surfactant | |
| Sodium Cumene Sulfonate (SCS) | Anionic Surfactant | 1.000-4.000 |
| Dipropylene Glycol solution of | Antimicrobial | 0.001-0.008 |
| 1,2-Benzisothiazolin-3-one | | |
| Glycolic Solvent including | Organic Solvent | 3.00-18.00 |
| propylene glycol and/or glycerol | | |
| Water | Solvent | 20.0-60.0 |

Table 3C shows Builder A, the builder for the non-phosphate based institutional laundry formulation of this example.

TABLE 3C
Builder A

| | | Concentration, |
|---|---|---|
| Compound | Function | wt % |
| Citric Acid 1H₂O | Bleach Enhancer | 5.00-12.00 |
| Carboxy Methyl Cellulose (CMC) | Anti-Redeposition | 0.200-0.700 |
| | Agent | |
| Methylglycinediacetic Acid | Chelating Agent | 0.800-2.100 |
| (MGDA) | | |
| Low Molecular Weight | Chelating Agent | 1.000-4.000 |
| Poly(Acrylic Acid) Homopolymer | | |
| Linear Alkyl Benzene | Anionic Surfactant | 1.000-3.500 |
| Sulfonic Acid (LABSA) | | |
| Oleic Acid | Anionic Surfactant | 0.300-1.500 |
| Sodium Cumene Sulfonate (SCS) | Anionic Surfactant | 1.500-4.500 |
| Glycolic Solvent including | Organic Solvent | 1.000-5.000 |
| propylene glycol and/or glycerol | | |
| Sodium Hydroxide | Alkali | 8.70-15.00 |
| Water | Solvent | 60.00-78.00 |

Table 4 shows the range of concentrations of the non-phosphate based system of this Example tested.

TABLE 4
Non-Phosphate Based System - Wash Bath Solution

| | | Concentration | |
|---|---|---|---|
| Compound | Function | Range | |
| Isoalcohol (C13) Ethoxylate | Non-ionic Surfactant | 180-220 | ppm |
| (3EO) | | | |
| 4,4′-Distyryl Biphenyl | Non-ionic Surfactant | 60-80 | ppm |
| Derivative (DSBP) | | | |
| Oleic Acid | Anionic Surfactant | 50-60 | ppm |
| LEVITI ® Integrate 100 L | Enzyme | 30-40 | ppm |
| Citric Acid | Bleach Enhancer | 180-240 | ppm |
| Peroxycarboxilic Acid (PAP), | Bleach | 120-250 | ppm |
| Peracetic Acid (PAA), | | | |
| Hydrogen Peroxide, Chlorine | | | |
| Organic Solvent | Solvents | 100-150 | ppm |
| Polypyrolidone | Dispersant | 4-6 | ppm |
| Carboxymethyl Cellulose | Anti-redeposition | 10-14 | ppm |
| Na-salt (CMC) | Agent | | |
| Methylglycinediacetic | Chelating Agent | 45-60 | ppm |
| Acid (MGDA) | | | |
| Polyacrylic Acid | Chelating Agent | 50-70 | ppm |

Table 5 compares the performance of the non-phosphate based system or System 1 as described in this Example to conventional institutional laundry wash systems.

TABLE 5

| | Comparative System | | | | | | System |
|---|---|---|---|---|---|---|---|
| | | | | | 3 | | 1 |
| | | | 2 | | Non- | non- | Non- |
| | 1 | | Non- | Non- | ionic + | ionic + | ionic + |
| | Non- | Non- | ionic + | ionic + | anionic + | anionic + | Anionic + |
| | ionic | ionic | anionic | anionic | Phosphates + | Phosphates + | Enzyme |
| Active | blend | blend | blend | blend | Protease | Protease | Cocktail |
| Active | 130 to | 130 to | 250 to | 250 to | 600 | 600 | 350 to |
| Concentration, | 200 | 200 | 400 | 400 | | | 400 |
| ppm | | | | | | | |
| Temperature, | 80 | 20 | 60 | 20 | 50 | 20 | 20 |
| ° C. | | | | | | | |

Performance on WFK Single Wash Monitor

| Soil | R-400 Value | | | | | |
|---|---|---|---|---|---|---|
| Food | 50.0 to | 50.0 to | 46.0 to | 58.0 to | 52.0 to | 58.0 to |
| | 54.0 | 54.0 | 50.0 | 62.0 | 56.0 | 62.0 |
| Milk Cocoa | 30.0 to | 32.0 to | 28.0 to | 39.5 to | 37.0 to | 40.5 to |
| | 34.0 | 36.0 | 32.0 | 43.5 | 41.0 | 43.5 |
| Blood/Milk/Carbon | 29.0 to | 36.0 to | 30.0 to | 36.0 to | 30.0 to | 36.0 to |
| Black | 32.0 | 40.0 | 34.0 | 40.0 | 34.0 | 40.0 |
| Pigment | 47.0 to | 55.0 to | 48.0 to | 52.0 to | 47.0 to | 53.0 to |
| | 51.0 | 59.0 | 51.0 | 56.0 | 51.0 | 57.0 |
| Starch/Pigment | 44.0 to | 44.0 to | 38.0 to | 44.0 to | 41.0 to | 46.0 to |
| | 48.0 | 48.0 | 42.0 | 48.0 | 45.0 | 50.0 |

Table 6 provides another comparison of the performance of the non-phosphate based system or System 1, as described in this Example, to conventional institutional laundry wash systems.

TABLE 6

| | | | | | | | System |
|---|---|---|---|---|---|---|---|
| | | | | | | | 1 |
| | Comparative System | | | | | | PAP + |
| | | | | | 6 | | Bleach |
| | 4 | | 5 | | Phthalimido- | Phthalimido- | Active |
| | Hydrogen | Hydrogen | Peracetic | Peracetic | peroxy | peroxy | Non- |
| | Peroxide | Peroxide | Acid | Acid | carboxylic | carboxylic | Phosphate- |
| Active | (H₂O₂) | (H₂O₂) | (PAA) | (PAA) | acid (PAP) | acid (PAP) | Based |
| Active | 180 | 180 | 110 | 110 | 160 | 160 | 160 + |
| Concentration, | | | | | | | 150 to 210 |
| ppm | | | | | | | |
| Temperature, | 80 | 20 | 60 | 20 | 50 | 20 | 20 |
| ° C. | | | | | | | |

Performance on WFK Single Wash Monitor

| Soil | R-400 Value | | | | | |
|---|---|---|---|---|---|---|
| Red Wine | 64.0 to | 64.0 to | 54.0 to | 70.0 to | 60.0 to | 70.0 to |
| | 68.0 | 70.0 | 58.0 | 74.0 | 64.0 | 74.0 |
| Tea | 60.0 to | 58.0 to | 38.0 to | 59.0 to | 50.0 to | 59.0 to |
| | 64.0 | 62.0 | 42.0 | 64.0 | 54.0 | 64.0 |
| Food (partial) | 50.0 to | 50.0 to | 46.0 to | 58.0 to | 50.0 to | 54.0 to |
| | 54.0 | 54.0 | 50.0 | 62.0 | 54.0 | 60.0 |

Table 7 provides another comparison of the performance of the non-phosphate based system or System 1 as described in this Example to conventional institutional laundry wash systems on the colors of the fabric samples.

TABLE 7

| | | | | | System |
|---|---|---|---|---|---|
| | | Comparative System | | | 1 |
| | | | | 3 | Non- |
| | | | 2 | Non- | Phosphate |
| | | 1 | Non- | ionic + | (Soil |
| | | Non- | ionic + | anionic | suspension + |
| | Unwashed | ionic | anionic | blend + | ARD agents) |
| Active | Wfk 11A | blend | blend | Phosphates | 60-100 ppm |
| Temperature, | | 80 | 60 | 50 | 20 |
| ° C. | | | | | |
| Whiteness | 76.0 to | 84.0- | 84.0- | 83.5 to | 84.1 to |
| (excluding | 80.0 | 88.0 | 88.0 | 87.5 | 88.0 |
| UV) | | | | | |
| Yellowness | 6.0 to | −1.5 | −1.5 | −1.5 | 0.0 to |
| | 8.0 | | | | 3.0 |
| Greyness | 1.5 to | 0.0 to | 1.0 to | 0.0 to | −1 |
| | 3.0 | 2.0 | 3.0 | 3.0 | |
| | Terry Towels | | | | |
| Whiteness | 83.0 to | NM | 82.0 to | 78.0 to | 86.0 to |
| (excluding | 85.0 | | 86.5 | 82.0 | 90.0 |
| UV) | | | | | |
| Yellowness | 1.5 to | NM | −2 | −3 | −2 |
| | 3.0 | | | | |
| Greyness | 0.5 to | NM | 2.0 to | 8.0 to | −1 |
| | 1.5 | | 5.0 | 10.0 | |

### Example 2

Table 8A shows the combination of the surfactant enzyme booster, builder and bleach for phosphate based institutional laundry formulations according to an embodiment of the invention.

TABLE 8A

| | Non-Phosphate Based Institutional | Concentration | |
|---|---|---|---|
| | Laundry Formulations | Range | |
| 1 | Surfactant enzyme booster Phosphate-based | 10 | mL/kg |
| 2 | Builder B | 3-5 | mL/kg |
| 3 | Bleach- conventional | 3-5 | mL/kg |

Table 8B shows the compounds and the range of concentrations such compounds may have in the surfactant enzyme booster combination for the phosphate based institutional laundry formulation of this example.

TABLE 8B
Surfactant Enzyme Booster Formulation
Phosphate Based

| | | Concentration, |
|---|---|---|
| Compound | Function | wt % |
| Sodium Hydroxide | Alkali | 0.20-1.00 |
| Sodium Triphosphate | Builder | 17.00-23.00 |
| Alcohol (C13-16) Ethoxylate | Nonionic | 1.50-4.00 |
| (7EO) | Surfactant | |
| Alkyl Benzene Sulfonic Acid | Anionic Surfactant | 4.00-8.00 |
| Distyryl-Biphenyl Derivative | Whitening Agent | 0.020-0.100 |
| Polydimethylsiloxane | Foam Control | 0.10-0.80 |
| | Agent | |
| LEVITI ® Integrate 100 L | Enzyme | 0.50-2.50 |
| Dipropylene Glycol solution of | Antimicrobial | 0.005-0.030 |
| 1,2-Benzisothiazolin-3-one | | |
| Perfume | Fragrance | 0.05-0.50 |
| Low Molecular Weight | Chelating Agent | 0.10-0.40 |
| Polymer Vinylpyrrolidone & | | |
| Vinylimidazole Copolymer | | |
| Enzyme Stabilizer including | Enzyme Stabilizer | 0.10-0.99 |
| Calcium Chloride Dihydrate | | |
| and/or Sodium Formulate | | |
| Glycolic Solvent including | Organic Solvent | 3.0-10.0 |
| propylene glycol and/or glycerol | | |
| Water | Solvent | 50.0-70.0 |

Table 8C shows Builder B, the builder for the phosphate based institutional laundry formulation of this example.

TABLE 8C
Builder B

| | | Concentration, |
|---|---|---|
| Compound | Function | wt % |
| Citric Acid 1H₂O | Bleach Enhancer | 8.000-12.000 |
| Carboxy Methyl Cellulose (CMC) | Anti-Redeposition | 0.600-1.200 |
| | Agent | |
| Sodium Hydroxide | Alkali | 4.000-12.000 |
| Water | Solvent | 75.00-85.00 |

Table 9 shows the range of concentrations of the non-phosphate based system of this Example tested.

TABLE 9
Phosphate Based System - Wash Bath Solution

| | | Concentration | |
|---|---|---|---|
| Compound | Function | Range | |
| Polyphosphate | Builder | 480-520 | ppm |
| Isoalcohol (C13) Ethoxylate | Non-ionic Surfactant | 50-60 | ppm |
| (3EO) | | | |
| Alkyl Benzene Sulfonic Acid | Anionic Surfactant | 50-60 | ppm |
| LEVITI ® Integrate 100 L | Enzyme | 30-45 | ppm |
| Citric Acid | Bleach Enhancer | 130-150 | ppm |
| Peroxycarboxilic Acid (PAP), | Bleach | 120-250 | ppm |
| Peracetic Acid (PAA), | | | |
| Hydrogen Peroxide, Chlorine | | | |
| Organic Solvent | Solvents | 80-120 | ppm |
| Polypyrolidone | Dispersant | 4-7 | ppm |
| Carboxymethyl Cellulose | Anti-redeposition | 10-14 | ppm |
| Na-salt (CMC) | Agent | | |

Table 10 compares the performance of the phosphate based system or System 2 as described in this Example to conventional institutional laundry wash systems; while Table 11 provides another comparison of the performance of the phosphate based system or System 2 as described in this Example to conventional institutional laundry wash systems.

TABLE 10

| | Comparative System | | | | | | System |
|---|---|---|---|---|---|---|---|
| | | | | | | | 2 |
| | | | | | 3 | | Non- |
| | | | 2 | | Non- | Non- | ionic + |
| | 1 | | Non- | Non- | ionic + | ionic + | anionic + |
| | Non- | Non- | ionic + | ionic + | anionic + | anionic + | Phosphates + |
| | ionic | ionic | anionic | anionic | Phosphates + | Phosphates + | Enzyme |
| Active | blend | blend | blend | blend | Protease | Protease | Cocktail |
| Active | 130 to | 130 to | 250 to | 250 to | 600 | 600 | 500 to |
| Concentration, | 200 | 200 | 400 | 400 | | | 600 |
| ppm | | | | | | | |
| Temperature, | 80 | 20 | 60 | 20 | 50 | 20 | 20 |
| ° C. | | | | | | | |

Performance on WFK Single Wash Monitor

| Soil | R-400 Value | | | | | |
|---|---|---|---|---|---|---|
| Food | 50.0 to | 50.0 to | 46.0 to | 58.0 to | 52.0 to | 57.0 to |
| | 54.0 | 54.0 | 50.0 | 62.0 | 56.0 | 61.0 |
| Milk Cocoa | 30.0 to | 32.0 to | 28.0 to | 39.5 to | 37.0 to | 39.0 to |
| | 34.0 | 36.0 | 32.0 | 43.5 | 41.0 | 43.0 |
| Blood/Milk/Carbon | 29.0 to | 36.0 to | 30.0 to | 36.0 to | 30.0 to | 41.5 to |
| Black | 32.0 | 40.0 | 34.0 | 40.0 | 34.0 | 44.5 |
| Pigment | 47.0 to | 55.0 to | 48.0 to | 52.0 to | 47.0 to | 51.5 to |
| | 51.0 | 59.0 | 51.0 | 56.0 | 51.0 | 54.5 |
| Starch/Pigment | 44.0 to | 44.0 to | 38.0 to | 44.0 to | 41.0 to | 46.5 to |
| | 48.0 | 48.0 | 42.0 | 48.0 | 45.0 | 50.0 |

TABLE 11

| | | | | | | | System |
|---|---|---|---|---|---|---|---|
| | | | | | | | 2 |
| | Comparative System | | | | | | PAP + |
| | | | | | 6 | | Bleach |
| | 4 | | 5 | | Phthalimido- | Phthalimido- | Active |
| | Hydrogen | Hydrogen | Peracetic | Peracetic | peroxy | peroxy | Non- |
| | Peroxide | Peroxide | Acid | Acid | carboxylic | carboxylic | Phosphate- |
| Active | (H₂O₂) | (H₂O₂) | (PAA) | (PAA) | acid (PAP) | acid (PAP) | Based |
| Active | 180 | 180 | 110 | 110 | 160 | 160 | 110 + |
| Concentration, | | | | | | | 150 to 210 |
| ppm | | | | | | | |
| Temperature, | 80 | 20 | 60 | 20 | 50 | 20 | 20 |
| ° C. | | | | | | | |

Performance on WFK Single Wash Monitor

| Soil | R-400 Value | | | | | |
|---|---|---|---|---|---|---|
| Red Wine | 64.0 to | 64.0 to | 54.0 to | 70.0 to | 60.0 to | 68.0 to |
| | 68.0 | 70.0 | 58.0 | 74.0 | 64.0 | 73.0 |
| Tea | 60.0 to | 58.0 to | 38.0 to | 59.0 to | 50.0 to | 59.0 to |
| | 64.0 | 62.0 | 42.0 | 64.0 | 54.0 | 63.0 |
| Food (partial) | 50.0 to | 50.0 to | 46.0 to | 58.0 to | 50.0 to | 57.0 to |
| | 54.0 | 54.0 | 50.0 | 62.0 | 54.0 | 63.0 |

Table 12 provides another comparison of the performance of the phosphate based system or System 2 as described in this Example to conventional institutional laundry wash systems on the colors of the fabric samples.

TABLE 12

| | | Comparative System | | | System |
|---|---|---|---|---|---|
| | | | | 3 | 2 |
| | | | 2 | Non- | Phosphate |
| | | 1 | Non- | ionic + | (Soil |
| | | Non- | ionic + | anionic | suspension + |
| | Unwashed | ionic | anionic | blend + | ARD agents) |
| Active | Wfk 11A | Blend | blend | Phosphates | 60-100 ppm |
| Temperature, | | 80 | 60 | 50 | 20 |
| ° C. | | | | | |
| Whiteness | 76.0 to | 84.0- | 84.0- | 83.5 to | 86.5 |
| (excluding | 80.0 | 88.0 | 88.0 | 87.5 | |
| UV) | | | | | |
| Yellowness | 6.0 to | −1.5 | −1.5 | −1.5 | 1.3 |
| | 8.0 | | | | |
| Greyness | 1.5 to | 0.0 to | 1.0 to | 0.0 to | 0 |
| | 3.0 | 2.0 | 3.0 | 3.0 | |
| | Terry Towels | | | | |
| Whiteness | 83.0 to | NM | 82.0 to | 78.0 to | 81.6 to |
| (excluding | 85.0 | | 86.5 | 82.0 | 85.6 |
| UV) | | | | | |
| Yellowness | 1.5 to | NM | −2 | −3 | −2.5 |
| | 3.0 | | | | |
| Greyness | 0.5 to | NM | 2.0 to | 8.0 to | 3.0 to |
| | 1.5 | | 5.0 | 10.0 | 6.0 |

### Example 3

This example focuses upon certain combinations of formulations of the invention that have been tested but they may be less preferred than the examples included in Example 2, for example. Without intending to be limiting, these formulations may be less preferred due to any one or more of formula stability factors that have not been met, cost performance, and regulatory considerations in certain geographic regions where there may be interest in commercializing such a formulation. However, in the event none of these factors are encountered for a particular type of institutional laundry operation, in a particular geographic region where regulatory limitations are non-existent, or operating conditions where such formulations prove stable, then the formulations identified herein may otherwise prove useful.

Table 13A shows a comparative example to Table 3B for a range of a formulation of the surfactant enzyme booster for the non-phosphate based institutional laundry formulation that have been tested but may not meet the requirements under certain conditions as otherwise provided herein.

The formulation of Table 13A may be less preferred in certain embodiments of the invention depending upon, inter alia, formula stability factors that have not been met, cost performance, regulatory considerations in certain geographic regions where there may be interest in commercializing such a formulation, and the like.

TABLE 13A
Surfactant Enzyme Booster Formulation
Non-Phosphate Based
Comparative Example 1

| | | Concentration, |
|---|---|---|
| Compound | Function | wt % |
| LEVITI ® Integrate 100 L | Enzyme | 3.00-10.00 |
| Alcohol (C13-16) Ethoxylate | Nonionic | 20.00-40.00 |
| (7EO) | Surfactant | |
| Isoalcohol (C13) Ethoxylate | Nonionic | 5.00-14.00 |
| (3EO) | Surfactant | |
| 4.4′-Distyryl Biphenyl | Nonionic | 0.60-2.80 |
| Derivative (DSBP) | Surfactant | |
| Oleic Acid | Anionic Surfactant | 5.00-12.00 |
| Sodium Cumene Sulfonate (SCS) | Anionic Surfactant | 1.00-4.00 |
| Dipropylene Glycol solution of | Antimicrobial | 0.001-0.008 |
| 1,2-Benzisothiazolin-3-one | | |
| Butyl Diglycol | Organic Solvent | 10.00-20.00 |
| Glycolic Solvent including | Organic Solvent | 3.00-10.00 |
| propylene glycol and/or glycerol | | |
| Water | Solvent | 20.00-40.00 |

Table 13B shows a comparative example to Builder A for the non-phosphate based institutional laundry formulation of Table 3C.

TABLE 13B
Builder A
Comparative Example 1

| | | Concentration, |
|---|---|---|
| Compound | Function | wt % |
| Manganese Gluconate | Bleach Enhancer | 0.10-0.50 |
| Methylglycinediacetic | Chelating Agent | 0.80-2.10 |
| Acid (MGDA) | | |
| Low Molecular Weight | Chelating Agent | 5.00-13.00 |
| Poly(Acrylic Acid) Homopolymer | | |
| Linear Alkyl Benzene | Anionic Surfactant | 1.00-3.50 |
| Sulfonic Acid (LABSA) | | |
| Low Molecular Weight | Builder Additive | 0.10-0.40 |
| Vinylpyrrolidone and | | |
| Vinylimidazole Copolymer | | |
| Oxidoreductases Enzyme | Enzyme | 0.50-1.80 |
| (Laccases Enzyme) | | |
| Sodium Hydroxide | Alkali | 8.70-15.00 |
| Water | Solvent | 60.00-78.00 |

The formulation of Comparative Example 1 in Table 13B may be less preferred in certain embodiments of the invention depending upon, inter alia, formula stability factors that have not been met, cost performance, regulatory considerations in certain geographic regions where there may be interest in commercializing such a formulation, and the like.

In comparison to Table 3C, the builder of Table 13B does not include a bleach enhancer, such as, for example, citric acid 1H₂O and an anti-redeposition agent such as, for example, carboxy methyl cellulose (CMC). The formulation of Table 13B also includes an increased amount of the chelating agent low molecular weight poly(acrylic acid) homopolymer—from about 5 wt % to about 13 wt %—over that found in the builder of Table 3C—from about 1 wt % to about 4 wt %.

Table 14A shows a comparative example to Table 3B for a range of a formulation of the surfactant enzyme booster for the non-phosphate based institutional laundry formulation that have been tested but may not meet the requirements under certain conditions as otherwise provided herein.

TABLE 14A
Surfactant Enzyme Booster Formulation
Non-Phosphate Based
Comparative Example 2

| | | Concentration, |
|---|---|---|
| Compound | Function | wt % |
| LEVITI ® Integrate 100 L | Enzyme | 3.00-8.00 |
| Alcohol (C13-16) Ethoxylate | Nonionic | 8.00-20.00 |
| (7EO) | Surfactant | |
| Isoalcohol (C13) Ethoxylate | Nonionic | 2.00-8.00 |
| (3EO) | Surfactant | |
| 4.4′-Distyryl Biphenyl | Nonionic | 0.20-1.20 |
| Derivative (DSBP) | Surfactant | |
| Oleic Acid | Anionic Surfactant | 2.00-8.00 |
| Sodium Cumene Sulfonate (SCS) | Anionic Surfactant | 3.00-10.00 |
| Dipropylene Glycol solution of | Antimicrobial | 0.001-0.008 |
| 1,2-Benzisothiazolin-3-one | | |
| Butyl Diglycol | Organic Solvent | 2.00-10.00 |
| Glycolic Solvent including | Organic Solvent | 3.00-10.00 |
| propylene glycol and/or glycerol | | |
| Water | Solvent | 40.00-60.00 |

The formulation of Table 14A may be less preferred in certain embodiments of the invention depending upon, inter alia, formula stability factors that have not been met, cost performance, regulatory considerations in certain geographic regions where there may be interest in commercializing such a formulation, and the like.

The surfactant enzyme booster formulation of Table 14A provides a range having a reduced amount of the nonionic surfactant alcohol (C13-16) ethoxylate (3EO)—from about 8 wt % to about 20 wt %—versus the range of alcohol (C13-16) ethoxylate (3EO) identified in Table 3B—from about 20 wt % to about 40 wt %. Also, the range for the isoalcohol (C13) ethoxylate (3EO) nonionic surfactant—from about 2 wt % to about 8 wt %—is generally reduced over the range identified in Table 3B—from about 5 wt % to about 14 wt %. In addition to these nonionic surfactants, the ranges of other compounds in Table 14A vary over that found in Table 3B as well.

Table 14B shows a comparative example to Builder A for the non-phosphate based institutional laundry formulation of Table 3C that may be less preferred in certain embodiments of the invention depending upon, inter alia, formula stability factors that have not been met, cost performance, regulatory considerations in certain geographic regions where there may be interest in commercializing such a formulation, and the like.

TABLE 14B
Builder A
Comparative Example 2

| | | |
|---|---|---|
| | | Concentration, |
| Compound | Function | wt % |

Formulae 1

| | | |
|---|---|---|
| Citric Acid 1H₂O (91%) | Bleach Enhancer | 8.0-12.00 |
| Sodium Persulfate | Anionic Surfactant | 1.00-3.50 |
| SOKALAN ® HP 56 K | Additive | 0.10-0.40 |
| Water | Solvent | 84.10-90.90 |

Formulae 2

| | | |
|---|---|---|
| Carboxy Methyl Cellulose (CMC) | Anti-Redeposition | 0.60-1.90 |
| | Agent | |
| Methyglycinediacetic Acid | Chelating Agent | 0.80-18.0 |
| (MGDA) | | |
| Low Molecular Weight | Chelating Agent | 0.80-18.0 |
| Poly(Acrylic Acid) Homopolymer | | |
| Sodium Hydroxide | Alkali | 28.00-38.00 |
| Water | Solvent | 45.00-60.00 |

The formulation of Table 14B is actually a combination of formulae for two builders with the first formulae including SOKALAN® HP 56 K (a product of BASF based in based in Ludwigshafen, Germany) that are characterized as water-soluble homo- and copolymers of vinylpyrrolidone, vinylimidazole and nonionic monomers. The Sokalan® HP range is particularly effective in preventing reactive and direct dyes from being transferred on clean fabrics by forming polymer/dye associates in the wash liquor.

The combination of Formulae 1 and Formulae 2 of Table 14B may be less preferred in certain embodiments of the invention depending upon, inter alia, formula stability factors that have not been met, cost performance, regulatory considerations in certain geographic regions where there may be interest in commercializing such a formulation, and the like.

Table 15A shows a comparative example to Table 8B for a range of a formulation of the surfactant enzyme booster for the non-phosphate based institutional laundry formulation that have been tested but may not meet the requirements under certain conditions as otherwise provided herein.

TABLE 15A
Surfactant Enzyme Booster Formulation
Phosphate Based
Comparative Example 1

| | | Concentration, |
|---|---|---|
| Compound | Function | wt % |
| Sodium Hydroxide | Alkali | 0.20-1.00 |
| Sodium Triphosphate | Builder | 17.00-23.00 |
| Alcohol (C13-16) Ethoxylate | Nonionic | 1.50-4.00 |
| (7EO) | Surfactant | |
| Alkyl Benzene Sulfonic Acid | Anionic Surfactant | 4.00-8.00 |
| Distyryl-Biphenyl Derivative | Whitening Agent | 0.020-0.100 |
| Polydimethylsiloxane | Foam Control | 0.10-0.80 |
| | Agent | |
| LEVITI ® Integrate 100 L | Enzyme | 0.50-2.50 |
| Dipropylene Glycol solution of | Antimicrobial | 0.005-0.030 |
| 1,2-Benzisothiazolin-3-one | | |
| Perfume | Fragrance | 0.050-0.50 |
| Low Molecular Weight | Chelating Agent | 0.10-0.40 |
| Poly(Acrylic Acid) Homopolymer | | |
| Oxidoreductases Enzyme | Enzyme | 0.50-1.80 |
| (Laccases Enzyme) | | |
| Calcium Chloride Dihydrate | Enzyme Stabilizer | 0.100-0.990 |
| and/or Sodium Formate | | |
| Glycolic Solvent including | Organic Solvent | 3.00-10.00 |
| propylene glycol and/or glycerol | | |
| Water | Solvent | 50.00-70.00 |

Table 15B shows a comparative example to Builder B for the non-phosphate based institutional laundry formulation of Table 8C that may be less preferred in certain embodiments of the invention depending upon, inter alia, formula stability factors that have not been met, cost performance, regulatory considerations in certain geographic regions where there may be interest in commercializing such a formulation, and the like. In comparison to Table 8C, the builder of Table 15B includes the bleach enhancer manganese gluconate in a range of from about 0.1 wt % to about 0.3 wt %.

TABLE 15B
Builder B
Comparative Example 1

| | | Concentration, |
|---|---|---|
| Compound | Function | wt % |
| Citric Acid 1H₂O | Bleach Enhancer | 8.000-12.000 |
| Carboxy Methyl Cellulose (CMC) | Anti-Redeposition | 0.600-1.200 |
| | Agent | |
| Manganese Gluconate | Bleach Enhancer | 0.10-0.30 |
| Sodium Hydroxide | Alkali | 4.000-12.000 |
| Water | Solvent | 75.00-85.00 |

Many modifications and other embodiments of the invention set forth herein will come to mind to one skilled in the art to which this invention pertains having the benefit of the teachings presented in the descriptions herein. It will be appreciated by those skilled in the art that changes could be made to the embodiments described herein without departing from the broad inventive concept thereof. Therefore, it is understood that this invention is not limited to the particular embodiments disclosed, but it is intended to cover modifications within the spirit and scope of the present invention as defined by the included claims.

1.-60. (canceled)

61. A method of cleaning a fabric in an institutional laundry machine, the method comprising:
prewashing the fabric by including a surfactant enzyme booster formulation in a wash solution, wherein the surfactant enzyme booster formulation comprises surfactant and prewash enzyme;
washing the fabric by including a detergent formulation in the wash solution;
at least one of draining and extracting the wash solution to remove any remaining and spent surfactant enzyme booster formulation and detergent formulation from the fabric; and
rinsing the fabric using an aqueous solution.

62. The method of claim 61, wherein a pH of prewashing is about 7.

63. The method of claim 61, wherein the institutional laundry machine is not subjected to draining following the prewashing step and before the washing step.

64. The method of claim 61, wherein the prewash enzyme comprises a protease enzyme, a lipase enzyme, an amylase enzyme, a cellulase enzyme, a mannanase enzyme, a pectinase enzyme, or any combination thereof.

65. The method of claim 61, wherein the surfactant comprises a non-ionic surfactant, an anionic surfactant, or a mixture thereof.

66. The method of claim 65, wherein the non-ionic surfactant comprises an alcohol ethoxylate.

67. The method of claim 66, wherein the alcohol ethoxylate fulfills at least one of the following:
(a) the alcohol ethoxylate has an average of from about C10 to about C18 linear alcohol ethoxylate, and an average of from about 3 moles to about 7 moles of ethylene oxide;
(b) the alcohol ethoxylate comprises at least one of a linear alcohol ethoxylate and a branched alcohol ethoxylate;
(c) the alcohol ethoxylate has an average of from about C11 to about C14, and an average of about 8 moles of ethylene oxide.

68. The method of claim 65, wherein the anionic surfactant comprises an oleic acid or any salt thereof, an alkylbenzene sulfonic acid or any salt thereof, or any combination thereof.

69. The method of claim 61, wherein the surfactant enzyme booster formulation further comprises an organic solvent, a polyphosphate salt, or a mixture thereof.

70. The method of claim 69, wherein the organic solvent comprises a propylene glycol, a glycerol, or a mixture thereof.

71. The method of claim 61, wherein the surfactant enzyme booster formulation is substantially free of a phosphate.

72. The method of claim 61, wherein the detergent formulation comprises a bleach agent and a bleach enhancer.

73. The method of claim 72, wherein the bleach agent comprises hydrogen peroxide, peracetic acid, chlorine, a peroxy phthalimido alkanoic acid, or any combination thereof.

74. The method of claim 72, wherein the bleach enhancer comprises citric acid or salt thereof, potassium sodium persulfate, manganese gluconate, a laccase enzyme, or any combination thereof.

75. The method of claim 72, wherein the detergent formulation further comprises a chelate agent, an anti-redeposition agent, a builder, or any combination thereof.

76. The method of claim 75, wherein the method fulfills at least one of the following:
(a) the chelate agent comprises a methylglycinediacetic acid or any salt or derivative thereof;
(b) the anti-redeposition agent comprises carboxymethyl cellulose;
(c) the builder comprises an acrylic acid homopolymer, a double salt of potassium sulfate and aluminum sulfate, a mixture of an aromatic polyester and a zeolite, or any combination thereof;

77. The method of claim 71, wherein the detergent formulation further comprises a wash enzyme.

78. The method of claim 77, wherein the wash enzyme comprises a laccase enzyme.

79. The method of claim 61, wherein the washing the fabric comprises:
raising a pH of the wash solution to a range of from about 7 to about 9 using a portion of the detergent formulation, and
adding a remainder of the detergent formulation to the wash solution.

80. The method of claim 79, wherein the bleach agent substantially inactivates any active enzymes remaining in the wash solution.
